(19) United States
(12) Patent Application Publication
(10) Pub. No.: US 2026/0091634 A1
(43) Pub. Date: Apr. 2, 2026

(54) METHOD OF RECOGNIZING A HEIGHT OF A SPEED BUMP AND MODIFYING FUNCTIONALITY OF A VEHICLE

(71) Applicant: Volvo Car Corporation, Göteborg (SE)

(72) Inventors: Oskar Nilsson, Göteborg (SE); Tulio Batista Rodrigues Da Silva, Göteborg (SE); Peter Vagerstam, Göteborg (SE)

(73) Assignee: Volvo Car Corporation, Göteborg (SE)

(21) Appl. No.: 18/899,713

(22) Filed: Sep. 27, 2024

(51) Int. Cl. B60G 17/0165; B60W 10/20; B60W 10/22; B60W 30/14; B60W 50/14

(52) U.S. Cl. CPC B60G 17/0165; B60W 10/22; B60W 30/143; B60W 50/14; B60G 2400/823; B60W 10/20; B60W 2050/143; B60W 2050/146; B60W 2420/403; B60W 2540/229; B60W 2552/35

(57) ABSTRACT

According to an embodiment, disclosed is a system comprising one or more sensors and a processor storing instructions in non-transitory memory that, when executed, cause the processor to detect, via the sensors of a vehicle, a road deformity that the vehicle is approaching from a distance, determine at least a characteristic of the road deformity, provide an alert comprising a message to an occupant of the vehicle, determine a ground clearance required for the vehicle to clear the road deformity based on a current vehicle state and a comfort level based on a current state of the occupant, and adjust temporarily at least a parameter of the vehicle to clear the road deformity.

### FIELD OF THE INVENTION

The technical field generally relates to systems and methods for recognizing a road deformity and more particularly related to systems and methods for detecting a road deformity and its characteristics, for example, a height of a speed bump and modifying the functionality of a vehicle accordingly.

### BACKGROUND

The problem is that when the driver encounters a road deformity, such as a bump on the road or a pothole, it is difficult for the driver to gauge how high the bump, or deep the pothole, is or if the suspension can handle the vehicle going over the road deformity. It would be preferred if the driver is notified in advance about the height of the bump or depth of the pothole, respectively.

Therefore, there is a need for a system and a method for recognizing a road deformity and modifying functionality of a vehicle.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

According to an embodiment, disclosed is a system comprising one or more sensors; and a processor storing instructions in non-transitory memory that, when executed, cause the processor to detect, via the sensors of a vehicle, a road deformity that the vehicle is approaching from a distance; determine at least a characteristic of the road deformity; provide an alert comprising a message to an occupant of the vehicle; determine a ground clearance required for the vehicle to clear the road deformity based on a current vehicle state and a comfort level based on a current state of the occupant; and adjust temporarily at least a parameter of the vehicle to clear the road deformity.

According to an embodiment, disclosed is a method comprising detecting, via one or more sensors of a vehicle, a road deformity that the vehicle is approaching from a distance; determining at least a characteristic of the road deformity; providing an alert comprising a message to an occupant of the vehicle; determining a ground clearance required for the vehicle to clear the road deformity based on a current vehicle state and a comfort level based on a current state of the occupant; and adjusting temporarily at least a parameter of the vehicle to clear the road deformity.

According to an embodiment, disclosed is a non-transitory computer-readable medium having stored thereon instructions executable by a computer system to perform operations comprising detecting, via one or more sensors of a vehicle, a road deformity that the vehicle is approaching from a distance; determining at least a characteristic of the road deformity; providing an alert comprising a message to an occupant of the vehicle; determining a ground clearance required for the vehicle to clear the road deformity based on a current vehicle state and a comfort level based on a current state of the occupant; and adjusting temporarily at least a parameter of the vehicle to clear the road deformity.

According to an embodiment, disclosed is a system comprising one or more sensors; and a processor storing instructions in non-transitory memory that, when executed, cause the processor to detect, via the sensors of a vehicle, a road deformity that the vehicle is approaching from a distance; determine at least a characteristic of the road deformity; provide an alert comprising a message to an occupant of the vehicle; determine a ground clearance required for the vehicle to clear the road deformity based on a current vehicle state and a comfort level based on a current state of the occupant; and display a strategy to navigate the road deformity to maintain at least the comfort level of the occupant; and display a video showing the strategy.

According to an embodiment, disclosed is a method comprising detecting, via one or more sensors of a vehicle, a road deformity that the vehicle is approaching from a distance; determining at least a characteristic of the road deformity; providing an alert comprising a message to an occupant of the vehicle; determining a ground clearance required for the vehicle to clear the road deformity based on a current vehicle state and a comfort level based on a current state of the occupant; and displaying a strategy to navigate the road deformity to maintain at least the comfort level of the occupant; and displaying a video showing the strategy.

According to an embodiment, disclosed is a system comprising a processor storing instructions in non-transitory memory that, when executed, cause the processor to determine a known road deformity in a route; determine at least a characteristic of the road deformity; provide an alert comprising a message to an occupant of a vehicle; determine a ground clearance required for the vehicle to clear the road deformity based on a current vehicle state and a comfort level based on a current state of the occupant; and suggest an alternate route to avoid the road deformity to maintain at least the comfort level of the occupant.

According to an embodiment, disclosed is a method comprising: determining a road deformity in a route, determining at least a characteristic of the road deformity, providing an alert comprising a message to an occupant of a vehicle, determining a ground clearance required for the vehicle to clear the road deformity based on a current vehicle state and a comfort level based on a current state of the occupant, and suggesting an alternate route to avoid the road deformity to maintain at least the comfort level of the occupant.

### BRIEF DESCRIPTION OF THE FIGURES

These and other aspects of the present invention will now be described in more detail, with reference to the appended drawings showing exemplary embodiments of the present invention, in which:

FIG. 1 shows the block diagram of the system to modify the functionality of the vehicle based on a road deformity information according to an embodiment.

FIG. 2 is an illustration of a vehicle with various sensors arranged strategically according to an embodiment.

FIG. 3 shows a block diagram of electronic components of a vehicle according to an embodiment.

FIG. 4 shows the road deformity detection module and its components according to an embodiment.

FIG. 5 shows the architecture of the system to modify the functionality of the vehicle based on a road deformity information according to an embodiment.

FIG. 6A shows vehicle state and occupant state parameters according to an embodiment.

FIG. 6B shows a vehicle interacting with the Cloud to gather the crowdsourced data of a geographic location according to an embodiment.

FIG. 7 shows an example block diagram for an Artificial Intelligence and Machine Learning (AI/ML) model to modify a functionality of the vehicle based on a road deformity information according to an embodiment.

FIG. 8A shows a structure of the neural network/machine learning model with a feedback loop according to an embodiment.

FIG. 8B shows a structure of the neural network/machine learning model with reinforcement learning according to an embodiment.

FIG. 8C shows a message that may be noted or displayed for the user according to an embodiment.

FIG. 9A shows a block diagram of a method executed by the vehicle to modify the functionality of the vehicle based on a road deformity information according to an embodiment.

FIG. 9B shows a block diagram of a system of a vehicle to modify the functionality of the vehicle based on a road deformity information according to an embodiment.

FIG. 9C shows a block diagram of the method executed by the non-transitory computer-readable medium to modify the functionality of the vehicle based on a road deformity information according to an embodiment.

FIG. 10A shows a block diagram of a method executed by a vehicle to modify the functionality of the vehicle based on a road deformity information according to an embodiment.

FIG. 10B shows a block diagram of a system of a vehicle to modify the functionality of the vehicle based on a road deformity information according to an embodiment.

FIG. 11A shows a block diagram of a method executed by a vehicle to modify a route of the vehicle based on a road deformity information according to an embodiment.

FIG. 11B shows a block diagram of a system of a vehicle to modify a route of the vehicle based on a road deformity information according to an embodiment.

FIG. 12 shows the block diagram of the cyber security module in view of the system and server according to an embodiment.

### DETAILED DESCRIPTION

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same element.

Although the detailed description herein contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs. The following terms and phrases, unless otherwise indicated, shall be understood to have the following meanings.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may be interchangeable with “one or more.” Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the terms “couple,” “coupled,” “couples,” “coupling,” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably,” “removable,” and the like, near the word “coupled” and the like does not mean that the coupling, etc. in question is or is not removable.

As used herein, the term “or” means an inclusive “or” rather than an exclusive “or.” That is, unless specified otherwise, or clear from context, “X employs A or B” means any of the natural inclusive permutations. That is, if X employs A; X employs B; or X employs both A and B, then “X employs A or B” is satisfied under any of the foregoing instances.

As used herein, two or more elements or modules are “integral” or “integrated” if they operate functionally together. Two or more elements are “non-integral” if each element can operate functionally independently.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As used herein the term “component” refers to a distinct and identifiable part, element, or unit within a larger system, structure, or entity. It is a building block that serves a specific function or purpose within a more complex whole. Components are often designed to be modular and interchangeable, allowing them to be combined or replaced in various configurations to create or modify systems. Components may be a combination of mechanical, electrical, hardware, firmware, software, and/or other engineering elements.

Digital electronic circuitry, or computer software, firmware, or hardware, including the structures disclosed in this specification and their structural equivalents, or in combinations of one or more of them may realize the implementations and all of the functional operations described in this specification. Implementations may be as one or more computer program products i.e., one or more modules of computer program instructions encoded on a computer-readable medium for execution by, or to control the operation of, data processing apparatus. The computer-readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc. may embed a computer. Computer-readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship with each other.

Embodiments of the present invention may comprise or utilize a special purpose or general-purpose computer including computer hardware. Embodiments within the scope of the present invention may also include physical and other computer-readable media for carrying or storing computer-executable instructions and/or data structures. Such computer-readable media can be any media accessible by a general purpose or special purpose computer system. Computer-readable media that store computer-executable instructions are physical storage media. Computer-readable media that carry computer-executable instructions are transmission media. Thus, by way of example and not limitation, embodiments of the invention can comprise at least two distinct kinds of computer-readable media: physical computer-readable storage media and transmission computer-readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer-readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer-readable media includes combinations of the above, which enable the transport of electronic data between computer systems and/or modules and/or other electronic devices. The term network may include the Internet, a local area network, a wide area network, or combinations thereof. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the Cloud. Cloud refers to servers that are accessed over the Internet, and the software and databases that run on those servers.

Further, upon reaching various computer system components, program code in the form of computer-executable instructions or data structures can be transferred automatically from transmission computer-readable media to physical computer-readable storage media (or vice versa). For example, computer-executable instructions or data structures received over a network or data link can be buffered in RAM within a Network Interface Module (NIC), and then eventually transferred to computer system RAM and/or to less volatile computer-readable physical storage media at a computer system. Thus, computer system components that also (or even primarily) utilize transmission media may include computer-readable physical storage media.

Computer-executable instructions comprise, for example, instructions and data which cause a general-purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer-readable media such as computer memory may practice the methods. In particular, one or more processors execute computer-executable instructions, stored in the computer memory, to perform various functions such as the acts recited in the embodiments.

Those skilled in the art will appreciate that the invention may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the invention. In a distributed system environment, program modules may be located in both local and remote memory storage devices.

As used herein, the term “Unauthorized access” is when someone gains access to a website, program, server, service, or other system using someone else's account or other methods. For example, if someone kept guessing a password or username for an account that was not theirs until they gained access, it is considered unauthorized access.

As used herein, the term “IoT” stands for Internet of Things which describes the network of physical objects “things” or objects embedded with sensors, software, and other technologies for the purpose of connecting and exchanging data with other devices and systems over the internet.

As used herein “Machine learning” refers to algorithms that give a computer the ability to learn without explicit programming, including algorithms that learn from and make predictions about data. Machine learning techniques include, but are not limited to, support vector machine, artificial neural network (ANN) (also referred to herein as a “neural net”), deep learning neural network, logistic regression, discriminant analysis, random forest, linear regression, rules-based machine learning, Naive Bayes, nearest neighbor, decision tree, decision tree learning, and hidden Markov, etc. For the purposes of clarity, part of a machine learning process can use algorithms such as linear regression or logistic regression. However, using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. The ANN may be featured with a feedback loop to adjust the system output dynamically as it learns from the new data as it becomes available. In machine learning, backpropagation and feedback loops are used to train the Artificial Intelligence/Machine Learning (AI/ML) model improving the model's accuracy and performance over time. Statistical modeling relies on finding relationships between variables (e.g., mathematical equations) to predict an outcome. ML models are also referred to as Artificial Intelligence (AI) model, Artificial Intelligence/Machine Learning (AI/ML) models, artificial intelligence algorithm, artificial intelligence (AI) engine, and artificial intelligence (AI) agent herein.

As used herein, the term “Data mining” is a process used to turn raw data into useful information. It is the process of analyzing large datasets to uncover hidden patterns, relationships, and insights that can be useful for decision-making and prediction.

As used herein, the term “Data acquisition” is the process of sampling signals that measure real world physical conditions and converting the resulting samples into digital numeric values that a computer manipulates. Data acquisition systems typically convert analog waveforms into digital values for processing. The components of data acquisition systems include sensors to convert physical parameters to electrical signals, signal conditioning circuitry to convert sensor signals into a form that can be converted to digital values, and analog-to-digital converters to convert conditioned sensor signals to digital values. Stand-alone data acquisition systems are often called data loggers.

As used herein, the term “Dashboard” is a type of interface that visualizes particular Key Performance Indicators (KPIs) for a specific goal or process. It is based on data visualization and infographics.

As used herein, a “Database” is a collection of organized information so that it can be easily accessed, managed, and updated. Computer databases typically contain aggregations of data records or files.

As used herein, the term “Data set” (or “Dataset”) is a collection of data. In the case of tabular data, a data set corresponds to one or more database tables, where every column of a table represents a particular variable, and each row corresponds to a given record of the data set in question. The data set lists values for each of the variables, such as height and weight of an object, for each member of the data set. Each value is known as a datum. Data sets can also consist of a collection of documents or files.

As used herein, a “sensor” is a device that detects and measures physical properties from the surrounding environment and converts this information into electrical or digital signals for further processing. Sensors play a crucial role in collecting data for various applications across industries. Sensors may be made of electronic, mechanical, chemical, or other engineering components. Examples include sensors to measure temperature, pressure, humidity, proximity, light, acceleration, orientation etc.

The term “infotainment system” or “in-vehicle infotainment system” (IVI) as used herein refers to a combination of vehicle systems which are used to deliver entertainment and information. In an example, the information may be delivered to the driver and the passengers of a vehicle/occupants through audio/video interfaces, control elements like touch screen displays, button panel, voice commands, and more. Some of the main components of an in-vehicle infotainment systems are integrated head-unit, heads-up display, high-end Digital Signal Processors (DSPs), and Graphics Processing Units (GPUs) to support multiple displays, operating systems, Controller Area Network (CAN), Low-Voltage Differential Signaling (LVDS), and other network protocol support (as per the requirement), connectivity modules, automotive sensors integration, digital instrument cluster, etc.

The term “environment” or “surrounding” as used herein refers to surroundings and the space in which a vehicle is navigating. It refers to dynamic surroundings in which a vehicle is navigating which includes other vehicles, obstacles, pedestrians, lane boundaries, traffic signs and signals, speed limits, potholes, snow, water logging etc.

The term “autonomous mode” as used herein refers to an operating mode which is independent and unsupervised.

The term “vehicle” as used herein refers to a thing used for transporting people or goods. Automobiles, cars, trucks, buses etc. are examples of vehicles.

The term “autonomous vehicle” also referred to as self-driving vehicle, driverless vehicle, robotic vehicle as used herein refers to a vehicle incorporating vehicular automation, that is, a vehicle that can sense its environment and move safely with little or no human input. Self-driving vehicles combine a variety of sensors to perceive their surroundings, such as thermographic cameras, Radio Detection and Ranging (RADAR), Light Detection and Ranging (LIDAR), Sound Navigation and Ranging (SONAR), Global Positioning System (GPS), odometry and inertial measurement unit. Control systems are designed for the purpose of interpreting sensor information to identify appropriate navigation paths, as well as obstacles and relevant signage.

The term “communication module” or “communication system” as used herein refers to a system which enables the information exchange between two points. The process of transmission and reception of information is called communication. The elements of communication include but are not limited to a transmitter of information, channel or medium of communication and a receiver of information.

The term “autonomous communication” as used herein comprises communication over a period with minimal supervision under different scenarios and is not solely or completely based on pre-coded scenarios or pre-coded rules or a predefined protocol. Autonomous communication, in general, happens in an independent and an unsupervised manner. In an embodiment, a communication module is enabled for autonomous communication.

The term “communication connection” as used herein refers to a communication link. It refers to a communication channel that connects two or more devices for the purpose of data transmission. It may refer to a physical transmission medium such as a wire, or to a logical connection over a multiplexed medium such as a radio channel in telecommunications and computer networks. A channel is used for the information transfer of, for example, a digital bit stream, from one or several senders to one or several receivers. A channel has a certain capacity for transmitting information, often measured by its bandwidth in Hertz (Hz) or its data rate in bits per second. For example, a Vehicle-to-Vehicle (V2V) communication may wirelessly exchange information about the speed, location and heading of surrounding vehicles.

The term “communication” as used herein refers to the transmission of information and/or data from one point to another. Communication may be by means of electromagnetic waves. Communication is also a flow of information from one point, known as the source, to another, the receiver. Communication comprises one of the following: transmitting data, instructions, information or a combination of data, instructions, and information. Communication happens between any two communication systems or communicating units. The term communication, herein, includes systems that combine other more specific types of communication, such as: V2I (Vehicle-to-Infrastructure), V2N (Vehicle-to-Network), V2V (Vehicle-to-Vehicle), V2P (Vehicle-to-Pedestrian), V2D (Vehicle-to-Device), V2G (Vehicle-to-Grid), and Vehicle-to-Everything (V2X) communication.

The term “Vehicle-to-Vehicle (V2V) communication” refers to the technology that allows vehicles to broadcast and receive messages. The messages may be omni-directional messages, creating a 360-degree “awareness” of other vehicles in proximity. Vehicles may be equipped with appropriate software (or safety applications) that can use the messages from surrounding vehicles to determine potential crash threats as they develop.

The term “Vehicle-to-Everything (V2X) communication” as used herein refers to transmission of information from a vehicle to any entity that may affect the vehicle, and vice versa. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.).

The term “protocol” as used herein refers to a procedure required to initiate and maintain communication; a formal set of conventions governing the format and relative timing of message exchange between two communications terminals; a set of conventions that govern the interactions of processes, devices, and other components within a system; a set of signaling rules used to convey information or commands between boards connected to the bus; a set of signaling rules used to convey information between agents; a set of semantic and syntactic rules that determine the behavior of entities that interact; a set of rules and formats (semantic and syntactic) that determines the communication behavior of simulation applications; a set of conventions or rules that govern the interactions of processes or applications between communications terminals; a formal set of conventions governing the format and relative timing of message exchange between communications terminals; a set of semantic and syntactic rules that determine the behavior of functional units in achieving meaningful communication; a set of semantic and syntactic rules for exchanging information.

The term “communication protocol” as used herein refers to standardized communication between any two systems. An example communication protocol is a DSRC protocol. The DSRC protocol uses a specific frequency band (e.g., 5.9 GHz (Gigahertz)) and specific message formats (such as the Basic Safety Message, Signal Phase and Timing, and Roadside Alert) to enable communications between vehicles and infrastructure components, such as traffic signals and roadside sensors. DSRC is a standardized protocol, and its specifications are maintained by various organizations, including the Institute of Electrical and Electronics Engineers (IEEE) and Society of Automotive Engineers (SAE) International.

The term “bidirectional communication” as used herein refers to an exchange of data between two components. In an example, the first component can be a vehicle and the second component can be an infrastructure that is enabled by a system of hardware, software, and firmware.

The term “alert” or “alert signal” refers to a communication to attract attention. An alert may include visual, tactile, audible alert, and a combination of these alerts to warn drivers or occupants. These alerts allow receivers, such as drivers or occupants, the ability to react and respond quickly.

The term “in communication with” as used herein, refers to any coupling, connection, or interaction using signals to exchange information, message, instruction, command, and/or data, using any system, hardware, software, protocol, or format regardless of whether the exchange occurs wirelessly or over a wired connection.

The term “electronic control unit” (ECU), also known as an “electronic control module” (ECM), is usually a module that controls one or more subsystems. Herein, an ECU may be installed in a vehicle or other motor vehicle. It may refer to many ECUs, and can include but not limited to, Engine Control Module (ECM), Powertrain Control Module (PCM), Transmission Control Module (TCM), Brake Control Module (BCM) or Electronic Brake Control Module (EBCM), Central Control Module (CCM), Central Timing Module (CTM), General Electronic Module (GEM), Body Control Module (BCM), and Suspension Control Module (SCM). ECUs together are sometimes referred to collectively as the vehicles' computer or vehicles' central computer and may include separate computers. In an example, the electronic control unit can be an embedded system in automotive electronics. In another example, the electronic control unit is wirelessly coupled with automotive electronics.

The terms “non-transitory computer-readable medium” and “computer-readable medium” include a single medium or multiple media such as a centralized or distributed database, and/or associated caches and servers that store one or more sets of instructions. Further, the terms “non-transitory computer-readable medium” and “computer-readable medium” include any tangible medium that is capable of storing, encoding, or carrying a set of instructions for execution by a processor that, for example, when executed, cause a system to perform any one or more of the methods or operations disclosed herein. As used herein, the term “computer-readable medium” is expressly defined to include any type of computer-readable storage device and/or storage disk and to exclude propagating signals.

The term “Vehicle Data bus” as used herein represents the interface to the vehicle data bus (e.g., Controller Area Network (CAN), Local Interconnect Network (LIN), Ethernet/IP, FlexRay, and Media Oriented Systems Transport (MOST)) that may enable communication between the Vehicle on-board equipment (OBE) and other vehicle systems to support connected vehicle applications.

The term, “handshaking” refers to an exchange of predetermined signals between agents connected by a communications channel to assure each that it is connected to the other (and not to an imposter). This may also include the use of passwords and codes by an operator. Handshaking signals are transmitted back and forth over a communications network to establish a valid connection between two stations. A hardware handshake uses dedicated wires such as the request-to-send (RTS) and clear-to-send (CTS) lines in a Recommended Standard 232 (RS-232) serial transmission. A software handshake sends codes such as “synchronize” (SYN) and “acknowledge” (ACK) in a Transmission Control Protocol/Internet Protocol (TCP/IP) transmission.

The term “computer vision module” or “computer vision system” allows the vehicle to “see” and interpret the world around it. This system uses a combination of cameras, sensors, and other technologies such as Radio Detection and Ranging (RADAR), Light Detection and Ranging (LIDAR), Sound Navigation and Ranging (SONAR), Global Positioning System (GPS), and Machine learning algorithms, etc. to collect visual data about the vehicle's surroundings and to analyze that data in real-time. The computer vision system is designed to perform a range of tasks, including object detection, lane detection, and pedestrian recognition. It uses deep learning algorithms and other machine learning techniques to analyze visual data and make decisions about how to control the vehicle. For example, the computer vision system may use object detection algorithms to identify other vehicles, pedestrians, and obstacles in the vehicle's path. It can then use this information to calculate the vehicle's speed and direction, adjust its trajectory to avoid collisions, and apply the brakes or accelerate as needed. It allows the vehicle to navigate safely and efficiently in a variety of driving conditions.

As used herein, the term “driver” refers to such an occupant, even when that occupant is not actually driving the vehicle but is situated in the vehicle so as to be able to take over control and function as the driver of the vehicle when the vehicle control system hands over control to the occupant or driver or when the vehicle control system is not operating in an autonomous or semi-autonomous mode. The driver is also referred to as an operator of the vehicle.

The term “application server” refers to a server that hosts applications or software that delivers a business application through a communication protocol. An application server framework is a service layer model. It includes software components available to a software developer through an application programming interface. It is system software that resides between the operating system (OS) on one side, the external resources such as a database management system (DBMS), communications and Internet services on another side, and the users' applications on the third side.

The term “cyber security” as used herein refers to application of technologies, processes, and controls to protect systems, networks, programs, devices, and data from cyber-attacks.

The term “cyber security module” as used herein refers to a module comprising application of technologies, processes, and controls to protect systems, networks, programs, devices and data from cyber-attacks and threats. It aims to reduce the risk of cyber-attacks and protect against the unauthorized exploitation of systems, networks, and technologies. It includes, but is not limited to, critical infrastructure security, application security, network security, Cloud security, Internet of Things (IoT) security.

The term “encrypt” used herein refers to securing digital data using one or more mathematical techniques, along with a password or “key” used to decrypt the information. It refers to converting information or data into a code, especially to prevent unauthorized access. It may also refer to concealing information or data by converting it into a code. It may also be referred to as cipher, code, encipher, encode. A simple example is representing alphabets with numbers—say, ‘A’ is ‘01’, ‘B’ is ‘02’, and so on. For example, a message like “HELLO” will be encrypted as “0805121215,” and this value will be transmitted over the network to the recipient(s).

The term “decrypt” used herein refers to the process of converting an encrypted message back to its original format. It is generally a reverse process of encryption. It decodes the encrypted information so that only an authorized user can decrypt the data because decryption requires a secret key or password. This term could be used to describe a method of unencrypting the data manually or unencrypting the data using the proper codes or keys.

The term “cyber security threat” used herein refers to any possible malicious attack that seeks to unlawfully access data, disrupt digital operations, or damage information. A malicious act includes but is not limited to damaging data, stealing data, or disrupting digital life in general. Cyber threats include, but are not limited to, malware, spyware, phishing attacks, ransomware, zero-day exploits, trojans, advanced persistent threats, wiper attacks, data manipulation, data destruction, rogue software, malvertising, unpatched software, computer viruses, man-in-the-middle attacks, data breaches, Denial of Service (DoS) attacks, and other attack vectors.

The term “hash value” used herein can be thought of as fingerprints for files. The contents of a file are processed through a cryptographic algorithm, and a unique numerical value, the hash value, is produced that identifies the contents of the file. If the contents are modified in any way, the value of the hash will also change significantly. Example algorithms used to produce hash values: the Message Digest-5 (MD5) algorithm and Secure Hash Algorithm-1 (SHA1).

The term “integrity check” as used herein refers to the checking for accuracy and consistency of system related files, data, etc. It may be performed using checking tools that can detect whether any critical system files have been changed, thus enabling the system administrator to look for unauthorized alteration of the system. For example, data integrity corresponds to the quality of data in the databases and to the level by which users examine data quality, integrity, and reliability. Data integrity checks verify that the data in the database is accurate, and functions as expected within a given application.

The term “alarm” as used herein refers to a trigger when a component in a system or the system fails or does not perform as expected. The system may enter an alarm state when a certain event occurs. An alarm indication signal is a visual signal to indicate the alarm state. For example, when a cyber security threat is detected, a system administrator may be alerted via sound alarm, a message, a glowing LED, a pop-up window, etc. Alarm indication signal may be reported downstream from a detecting device, to prevent adverse situations or cascading effects.

As used herein, the term “cryptographic protocol” is also known as security protocol or encryption protocol. It is an abstract or concrete protocol that performs a security-related function and applies cryptographic methods often as sequences of cryptographic primitives. A protocol describes how the algorithms should be used. A sufficiently detailed protocol includes details about data structures and representations, at which point it can be used to implement multiple, interoperable versions of a program. Cryptographic protocols are widely used for secure application-level data transport. A cryptographic protocol usually incorporates at least some of these aspects: key agreement or establishment, entity authentication, symmetric encryption, and message authentication material construction, secured application-level data transport, non-repudiation methods, secret sharing methods, and secure multi-party computation. Hashing algorithms may be used to verify the integrity of data. Secure Socket Layer (SSL) and Transport Layer Security (TLS), the successor to SSL, are cryptographic protocols that may be used by networking switches to secure data communications over a network.

The embodiments described herein can be directed to one or more of a system, a method, an apparatus, and/or a computer program product at any possible technical detail level of integration. The computer program product can include a computer-readable storage medium (or media) having computer-readable program instructions thereon for causing a processor to carry out aspects of the one or more embodiments described herein.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer-readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a Cloud computing system.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

As used herein the term “Camera-Based Sensors” refers to sensors that utilize cameras as their primary sensing modality. These sensors incorporate camera technology to capture visual data, which is then processed and analyzed to extract relevant information. Camera-based sensors may further include additional components or functionalities beyond basic image capture, such as depth sensing, infrared imaging, or multispectral imaging. Camera-based sensors may encompass a variety of camera configurations and features tailored to specific monitoring tasks, such as road surface condition detection.

As used herein the term “monitoring” refers to systematic observation and assessment of a system, process, or environment in real-time or near real-time. It involves the regular collection, analysis, and interpretation of data using various sensors. Monitoring may be continuous or adaptive.

As used herein the term “adaptive monitoring” refers to an approach that dynamically adjusts its parameters, methods, or thresholds based on changing conditions, requirements, or feedback of the system. Unlike static monitoring systems with fixed configurations, adaptive monitoring systems have the ability to modify their behavior in response to evolving circumstances or user-defined criteria. For example, monitoring frequency may be changed based on remaining battery power, detected activity in the vehicle, road conditions, required accuracy, etc. Another example includes activating the sensors as needed.

The term “user” as used herein refers to any individual who is inside or on the vehicle (i.e., a communication system). Broadly it may encompass a user inside the vehicle. The terms occupant, passenger, person, may also be used interchangeably to refer to the user of the vehicle.

The term “vehicle system” or “system of a vehicle” as used herein refers to the vehicle comprising the system described in the current application. The system may be integrated and is a part of the vehicle, for example, a system executing a method on a processor storing instructions in a non-transitory memory of the computer system of the vehicle. The system may be external, but the instructions or method are executed through the vehicle, for example, the method being in a Cloud but is accessed and executed by the vehicle. The system may be designed for a specific purpose to carry out a certain function or task, for example, transmitting a specific message to a user device. The designed system comprising instructions may also be using existing systems present on the vehicle, for example, a communication system of the vehicle.

As used herein the term “road deformity” refers to any irregularity or imperfection in the surface of a roadway that deviates from its intended smooth and level condition. This can include various types of surface damage or alterations such as bumps, potholes, cracks, ruts, depressions, and uneven pavement. Any road deformities can impact driving safety, vehicle performance, and overall road usability which may also include obstructions on the road.

As used herein, “characteristic of a road deformity” refers to a specific attribute or feature that defines an irregularity or imperfection in the roadway surface. These characteristics include the type of deformity, such as bumps, potholes, cracks, ruts, or depressions, each with its distinct nature. The size of the deformity, encompassing its length, width, and depth or height, is a crucial factor in determining its impact. It also includes the location on the roadway where the deformity is present. The severity of the deformity indicates the extent of its impact, ranging from minor disruptions to significant hazards.

As used herein, “ground clearance” of a vehicle refers to the distance between the lowest point of the vehicle's underbody and the ground. This measurement determines the vehicle's ability to traverse uneven terrain without the undercarriage contacting the surface of the terrain.

As used herein, “temporary” refers to something that is intended to last for only a limited period of time, without permanence or long-term duration. Temporary situations, conditions, or solutions are typically implemented to address immediate needs or issues and are expected to be replaced or resolved with a more permanent option in the future. The term implies an expectation of change, transition, or eventual conclusion.

As used herein, “current state of a vehicle” refers to its present condition and operational status, encompassing various aspects such as mechanical performance, and structural integrity. This includes the functioning of critical systems like the engine, transmission, brakes, suspension, and electrical components. The current state can be assessed by using data from multiple/various sensors. It may include speed of the vehicle, steering wheel position, force applied for braking, load in the vehicle, etc., along with vehicle characteristics like ground clearance, gross weight, etc.

As used herein, “current state of an occupant” refers to the present physical and emotional condition of a person inside the vehicle, as well as their activities. This encompasses the individual's health, comfort, alertness, and overall well-being. It includes factors such as whether the occupant is properly seated and restrained, their level of fatigue or alertness, any injuries or medical conditions, and their emotional state, such as stress or calmness. Additionally, the current state involves what the occupant is doing, such as driving, navigating, talking, eating, using electronic devices, or resting. These activities can affect the occupant's ability to operate the vehicle safely and effectively or respond to driving conditions and emergencies.

As used herein, “comfort level of an occupant” refers to the degree of physical and emotional ease experienced by the person while seated inside the vehicle. This encompasses several factors such as seat ergonomics, cabin temperature, noise levels, vibration, air quality, and the smoothness of the ride. Additionally, the comfort level is influenced by the availability and functionality of in-car amenities like air conditioning, entertainment systems, and adjustable seating. To quantify the comfort level, subjective measures such as occupant feedback through surveys and questionnaires can be used, alongside objective measures like monitoring physiological responses (heart rate, skin temperature), amount of movement at various locations of the occupant body using sensors, and environmental parameters (decibel levels, temperature readings). These metrics provide a comprehensive assessment of the overall comfort experienced by the occupant during their time in the vehicle.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

The problem is that when the driver encounters a road deformity such as a bump on the road or a pothole, it is difficult for the driver to gauge how high the bump or deep the pothole is or if the suspension can handle the vehicle going over the bump. It would be preferred if the driver is notified in advance about the height of the bump or depth of the pothole, respectively.

In an aspect, the system scans the road using camera-based sensors and uses image processing to determine the height of a speed bump. The system can also extract data based on location and information available in a database on a cloud. The system can use information collected from one or more sources to determine if the height of the speed bump will damage the vehicle. The system may determine the ground clearance the vehicle has based on its current weight. For example, if the vehicle is carrying several passengers, the ground clearance may be low, and the vehicle may not clear the speed bump if traveling at the current trajectory. In such a case, the system can offer several options. One option could provide an alternate route. The other would suggest a way (e.g., display a video showing how to approach and/or navigate the bump, either diagonally or slowly) to go over the speed bump. In addition, the system can temporarily modify the suspension to minimize the impact of the vehicle going over the bump. In an aspect, the system can modify the suspension, lower the speed to avoid damage to the vehicle in the event that the driver ignores the alert to avoid damage to the vehicle. In another aspect, when a route is to be selected, if there are bumps or potholes on certain paths or routes that the vehicle may not be able to handle, the system avoids presenting the route having bumps and potholes.

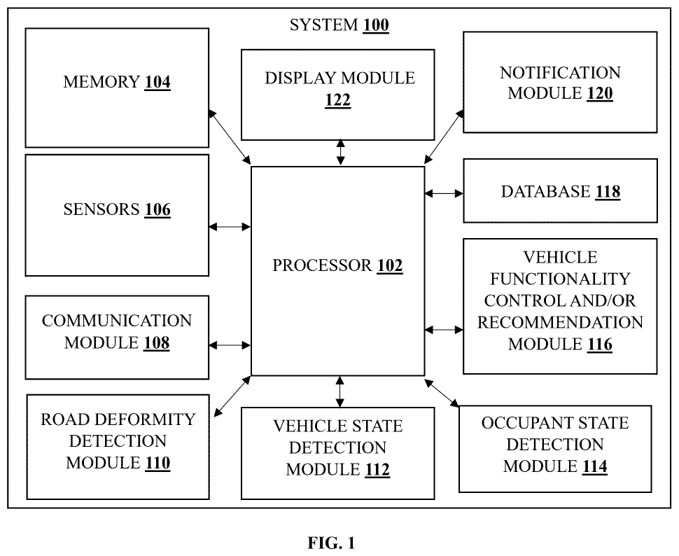

FIG. 1 shows the block diagram of the system to modify the functionality of the vehicle based on a road deformity information according to an embodiment. The system 100 comprises a processor 102, memory 104, sensors 106, communication module 108, road deformity detection module 110, vehicle state detection module 112, occupant state detection module 114, vehicle functionality control and/or recommendation module 116, database 118, notification module 120, and display module 122. FIG. 1 illustrates an example system that is not constrained by the depicted modules nor by their specific depiction. The modules may operate collaboratively and may not be distinct as shown. The emphasis is on the functionality provided by the modules, rather than their architecture, separation, or the manner of their depiction. The modules may be collaborating with other modules such as weather modules or climate modules to access the necessary information.

Processor 102: Processor may be a high-performance, multi-core CPU or system-on-chip (SoC) solution to process vast amounts of data from various sensors that may be used. Processor 102 processes data from sensors, such as cameras, LIDAR, radar, and other inputs to make real-time decisions, recommendations, and to execute control actions for the vehicle. Processor 102 may comprise Graphics Processing Units (GPUs). GPUs are utilized for their ability to accelerate tasks like image and sensor data processing. Some vehicles may incorporate Field-Programmable Gate Arrays (FPGAs) to efficiently perform specialized computations, while others might leverage Application-Specific Integrated Circuits (ASICs) for optimized functions. The choice of processor depends on factors such as the vehicle's level of autonomy, processing requirements, power consumption, and thermal considerations. Processors, also known as central processing units (CPUs), are the heart and brain of any computer or electronic device capable of executing instructions. Processor or processors' function is to process data and perform calculations, etc. At the core of their operation lies data processing, where they handle arithmetic and logical operations on data stored in memory. CPUs execute instructions, which are sets of specific operations encoded in machine language, to perform various tasks. The control unit within, or interacting with, the processor manages and coordinates the execution of instructions, fetching them from memory, decoding them, and directing the appropriate components to execute the instructions. To ensure a controlled and orderly flow of tasks, processors use an internal clock that generates regular electrical pulses, synchronizing their operations through clock cycles. Processors support multitasking environments, rapidly switching between executing different tasks for various applications. Additionally, they may work with the operating system to manage virtual memory, allowing programs to access more memory than is physically available, and to efficiently manage memory usage. Processors may be integrated with security features, including hardware-level encryption, memory protection, and support for secure execution environments, enhancing the system's security against potential threats. The processor may run sophisticated algorithms and artificial intelligence (AI) software to analyze sensor data, detect users, interpret the environment, and help in decision making. Its high-performance capabilities and parallel processing help ensure the vehicle can perceive and respond to its surroundings quickly and accurately. In an embodiment, the processor may be a neuromorphic processor, inspired by the human brain, which offers a unique approach to handling AI tasks. The processor interacts and exchanges data with one or more of the other components or modules of the system, for example, memory 104, sensors 106, communication module 108, road deformity detection module 110, vehicle state detection module 112, occupant state detection module 114, vehicle functionality control and/or recommendation module 116, database 118, notification module 120, and display module 122.

Memory 104: Memory may be a non-volatile memory (NVM) which is utilized in reliable operations of the system, ensuring that data is preserved even during power interruptions or failures. Various NVM technologies are utilized, such as flash memory for storing the operating system and software, EEPROM for retaining configuration data, calibration values, and sensor settings, Ferroelectric RAM (FRAM) for critical real-time information, and emerging technologies like ReRAM for potential performance enhancements due to its high-speed operation and low power consumption. In an embodiment, the memory may be a Cloud-based memory. In another embodiment, the memory may be a local memory. In another embodiment, it may be a combination of local and Cloud-based memory. Local memory refers to the traditional memory components present in a physical device, such as a computer's RAM, hard disk drives (HDDs), or solid-state drives (SSDs). It provides fast access to data and is directly connected to the device, making it suitable for immediate processing tasks and offline use. On the other hand, Cloud-based memory relies on remote servers and services provided by third-party Cloud providers to store and manage data over the internet. Systems can access their data from anywhere with an internet connection, allowing for seamless collaboration and scalability. Cloud-based memory is often used for storing large amounts of data, enabling data sharing, and providing backup and disaster recovery solutions. The combination of local memory and Cloud-based memory allows for flexible and efficient data management tailored to different needs of the system.

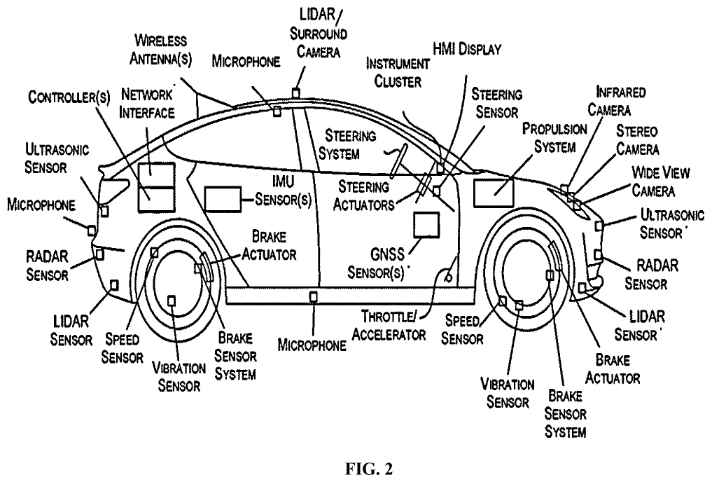

Sensors 106: FIG. 2 is an illustration of a vehicle with various sensors, actuators, and systems according to an embodiment. The system comprises various sensors, such as ultrasonic sensors, LIDAR sensors, accelerometers, gyroscope, radar sensors, camera-based sensors, infrared (IR) sensors, temperature sensors, humidity sensors, steering sensors, microphone etc. FIG. 2 is depicted as an example system; neither is it limited by the systems depicted nor is it an exhaustive list of the sensors, actuators, and systems/subsystems, and/or features of the vehicle. Further, the vehicle shown should not be construed as limiting in terms of the arrangement of any of the sensors, actuators, and systems/subsystems depicted. These sensors, actuators, and systems/subsystems can be arranged as suited for a purpose to be performed by the vehicle. In the case of autonomous vehicles, also known as self-driving vehicles or driverless vehicles, they can navigate and operate without human intervention. Sensors, for example, including cameras, camera-based sensors, LIDARs, radars, optical sensors, laser sensors, speed sensors, motion sensors, and ultrasonic sensors enable autonomous vehicles to detect and recognize objects, obstacles, and pedestrians on the road.

In an embodiment, sensors are activated to continuously monitor the surroundings and the road conditions. In an embodiment, sensors are activated to periodically monitor the surroundings and the road conditions. In an embodiment, sensors are activated to adaptively monitor the surroundings and the road conditions.

In an embodiment, the system may initially use certain sensors and identify more sensors to be activated that might be useful in sensing weather conditions, road conditions, or getting access to the required data from a database on the Cloud, etc. In an embodiment, some sensors are active to constantly monitor, and some are activated as needed to reduce the battery power consumption.

According to an embodiment of the system, the sensors comprise one or more of camera-based sensors, a Radio Detection and Ranging, a Light Detection and Ranging, an ultrasonic sensor, a thermal imaging camera, and an infrared camera.

According to an embodiment of the method, the sensors comprise one or more of camera-based sensors, a Radio Detection and Ranging, a Light Detection and Ranging, an ultrasonic sensor, a thermal imaging camera, and an infrared camera.

According to an embodiment of the system, the sensors comprise one or more of camera-based sensors, a Radio Detection and Ranging, a Light Detection and Ranging, an ultrasonic sensor, a thermal imaging camera, and an infrared camera.

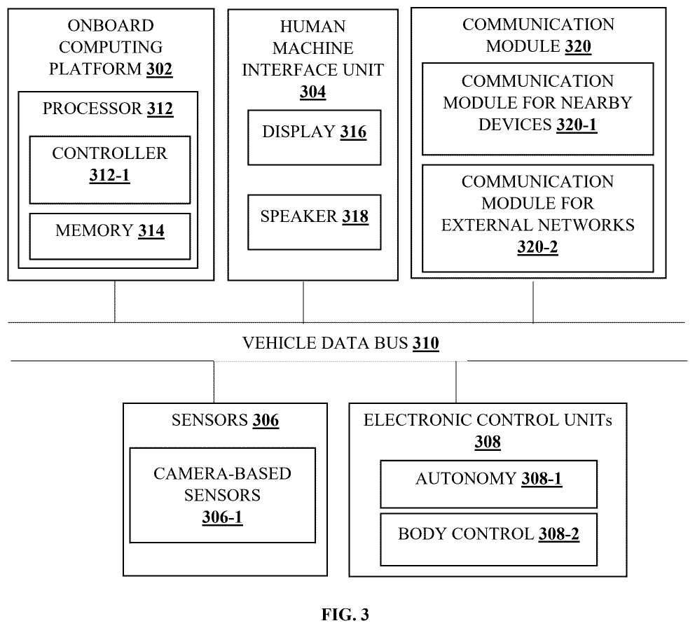

Communication module 108: Communication module facilitates communication between different modules within the system, communication between the vehicle and other devices, vehicle and other vehicles, vehicle and Cloud, and vehicle and other infrastructure components. FIG. 3 shows a block diagram of electronic components of a vehicle according to an embodiment. In the illustrated example, the electronic components comprise an onboard computing platform 302, a human-machine interface (HMI) unit 304, the communication module 320, sensors 306, electronic control units (ECUs) 308, and a vehicle data bus 310. FIG. 3 illustrates an example architecture of some of the electronic components as shown in FIG. 2. The onboard computing platform 302 comprises a processor 312 (also referred to as a microcontroller unit or a controller) and memory 314. In the illustrated example, processor 312 of the onboard computing platform 302 is structured to comprise the controller 312-1. In other examples, the controller 312-1 is incorporated into another ECU with its own processor and memory. The processor 312 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 314 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, memory 314 comprises multiple kinds of memory, particularly volatile memory, and non-volatile memory. Memory 314 is computer-readable media on which one or more sets of instructions, such as the software for operating the methods of the present disclosure, can be embedded. The instructions may embody one or more of the methods or logic as described herein. For example, the instructions reside completely, or at least partially, within any one or more of the memory 314, the computer-readable medium, and/or within the processor 312 during execution of the instructions.

The HMI unit 304 provides an interface between the vehicle and a user. The HMI unit 304 comprises digital and/or analog interfaces (e.g., input devices and output devices) to receive input from, and display information for, the user(s). The input devices comprise, for example, a control knob, an instrument panel, a digital camera for image capture and/or visual command recognition, a touch screen, an audio input device (e.g., cabin microphone), buttons, or a touchpad. The output devices may comprise instrument cluster outputs (e.g., dials, lighting devices), haptic devices, actuators, a display 316 (e.g., a heads-up display, a center console display such as a liquid crystal display (LCD), light emitting diode (LED) display, an organic light emitting diode (OLED) display, a flat panel display, a solid-state display, etc.), and/or a speaker 318. For example, the display 316, the speaker 318, and/or other input and output device(s) of the HMI unit 304 are operable to emit an alert, such as an alert to request manual takeover to an operator (e.g., a driver) of the vehicle. Further, the HMI unit 304 of the illustrated example comprises hardware (e.g., a processor or controller, memory, storage, etc.) and software (e.g., an operating system, etc.) for an infotainment system that is presented via display 316.

Sensors 306 are arranged in and/or around the vehicle to monitor the interior regions of the vehicle and/or an environment in which the vehicle is driving. One or more of the sensors 306 may be mounted to measure various parameters around an exterior of the vehicle. Additionally, or alternatively, one or more of sensors 306 may be mounted inside a cabin of the vehicle or in a body of the vehicle (e.g., an engine compartment, wheel wells, etc.) to measure properties of the vehicle and/or interior sensing of the vehicle. For example, the sensors 306 comprise accelerometers, odometers, tachometers, pitch and yaw sensors, wheel speed sensors, microphones, tire pressure sensors, biometric sensors, ultrasonic sensors, infrared sensors, Light Detection and Ranging (LIDAR/lidar), Radio Detection and Ranging System (radar), Global Positioning System (GPS), millimeter wave (mm Wave) sensors, cameras and/or sensors of any other suitable type. Sensors may comprise camera-based sensors 306-1 to take an image of the upcoming portion of the road and process to determine the presence of any road deformity. This may further be aided with other sensor information such as LIDARs, IR sensors, etc., via sensor fusion to determine the presence of any road deformity.

The ECUs 308 monitor and control the subsystems of the vehicle. For example, the ECUs 308 are discrete sets of electronics that comprise their own circuit(s) (e.g., integrated circuits, microprocessors, memory, storage, etc.) and firmware, sensors, actuators, and/or mounting hardware. The ECUs 308 communicate and exchange information via a vehicle data bus (e.g., the vehicle data bus 310). Additionally, the ECUs 308 may communicate properties (e.g., status of the ECUs, sensor readings, control state, error, and diagnostic codes, etc.) and/or receive requests from each other. For example, the vehicle may have many ECUs that are positioned in various locations around the vehicle and are communicatively coupled by the vehicle data bus 310.

In the illustrated example, the ECUs 308 comprise the autonomy unit 308-1 and a body control module 308-2. For example, the autonomy unit 308-1 is operable to perform autonomous and/or semi-autonomous driving maneuvers (e.g., defensive driving maneuvers) of the vehicle based upon, at least in part, instructions received from the controller 312-1 and/or data collected by the sensors 306 (e.g., camera-based sensors). Further, the body control module 308-2 controls one or more subsystems throughout the vehicle, such as power windows, power locks, an immobilizer system, power mirrors, etc. For example, the body control module 308-2 comprises circuits that drive one or more relays (e.g., to control wiper fluid, etc.), brushed direct current (DC) motors (e.g., to control power seats, power locks, power windows, wipers, etc.), stepper motors, LEDs, safety systems (e.g., seatbelt pretensioner, air bags, etc.), etc.

The vehicle data bus 310 communicatively couples the communication module 320, the onboard computing platform 302, the HMI unit 304, the sensors 306, and the ECUs 308. In some examples, the vehicle data bus 310 comprises one or more data buses. The vehicle data bus 310 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

The communication module for nearby devices 320-1 is operable to communicate with other nearby communication devices. In an example, communication module 320 comprises a dedicated short-range communication (DSRC) module. A DSRC module comprises antenna(s), radio(s) and software to communicate with nearby vehicle(s) via vehicle-to-vehicle (V2V) communication, infrastructure-based module(s) via vehicle-to-infrastructure (V2I) communication, and/or, more generally, nearby communication device(s) (e.g., a mobile device-based module) via vehicle-to-everything (V2X) communication. V2V communication allows vehicles to share information such as speed, position, direction, and other relevant data, enabling them to cooperate and coordinate their actions to improve safety, efficiency, and mobility on the road. It may rely on dedicated short-range communication (DSRC) and other wireless protocols that enable fast and reliable data transmission between vehicles. V2V communication, which is a form of wireless communication between vehicles, allows vehicles to exchange information and coordinate with other vehicles on the road.

Additionally, or alternatively, the communication module for external networks 320-2 comprises a cellular vehicle-to-everything (C-V2X) module. A C-V2X module comprises hardware and software to communicate with other vehicle(s) via V2V communication, infrastructure-based module(s) via V2I communication, and/or, more generally, nearby communication devices (e.g., mobile device-based modules) via V2X communication. For example, a C-V2X module is operable to communicate with nearby devices (e.g., vehicles, roadside units, mobile devices of users, etc.) directly and/or via cellular networks. Currently, standards related to C-V2X communication are being developed by the 3^{rd} Generation Partnership Project. Further, the communication module 320-2 is operable to communicate with external networks. For example, the communication module 320-2 comprises hardware (e.g., processors, memory, storage, antenna, etc.) and software to control wired or wireless network interfaces. In the illustrated example, the communication module 320-2 comprises one or more communication controllers for cellular networks (e.g., Global System for Mobile Communications (GSM), Universal Mobile Telecommunications System (UMTS), Long Term Evolution (LTE), Code Division Multiple Access (CDMA)), Near Field Communication (NFC) and/or other standards-based networks (e.g., WiMAX (IEEE 802.16m), local area wireless network (including IEEE 802.11 a/b/g/n/ac or others), Wireless Gigabit (IEEE 802.11ad), etc.). In some examples, the communication module for external networks 320-2 comprises a wired or wireless interface (e.g., an auxiliary port, a Universal Serial Bus (USB) port, a Bluetooth® wireless node, etc.) to communicatively couple with a mobile device (e.g., a smart phone, a wearable, a smart watch, a tablet, etc.). In such examples, the vehicle may communicate with the external network via the coupled mobile device. The external network(s) may be a public network, such as the Internet, a private network, such as an intranet, or combinations thereof, and may utilize a variety of networking protocols now available or later developed including, but not limited to, TCP/IP-based networking protocols.

The communication module comprises a hardware component comprising a vehicle gateway system comprising a microcontroller, a transceiver, a power management integrated circuit, an Internet of Things device capable of transmitting one of an analog and a digital signal over one of a telephone, a communication, either wired or wirelessly.

The autonomy unit 308-1 of the illustrated example is operable to perform autonomous and/or semi-autonomous driving maneuvers, such as defensive driving maneuvers, for the vehicle. For example, the autonomy unit 308-1 performs the autonomous and/or semi-autonomous driving maneuvers based on data collected by the sensors 306. In some examples, the autonomy unit 308-1 is operable to operate a fully autonomous system, a park-assist system, an advanced driver-assistance system (ADAS), and/or other autonomous system(s) for the vehicle.

Further, in the illustrated example, controller (or control module) 312-1 is operable to monitor an ambient environment of the vehicle. For example, to enable the autonomy unit 308-1 to perform autonomous and/or semi-autonomous driving maneuvers, the controller 312-1 collects data that is collected by sensors 306 of the vehicle. In some examples, the controller 312-1 collects location-based data via the communication module 320 and/or another module (e.g., a GPS receiver) to facilitate the autonomy unit 308-1 in performing autonomous and/or semi-autonomous driving maneuvers. Additionally, the controller 312-1 collects data from (i) adjacent vehicle(s) via the communication module 320-1 and vehicle-to-vehicle (V2V) communication and/or (ii) roadside unit(s) via the communication module 320-2 and vehicle-to-infrastructure (V2I) communication to further facilitate the autonomy unit 308-1 in performing autonomous and/or semi-autonomous driving maneuvers.

In an embodiment, a connection is established between a vehicle and the user device. The user device is detected by exchanging handshaking signals. Handshaking is the automated process for negotiation of setting up a communication channel between entities. The processor sends a start signal through the communication channel to detect a user device. If the user device receives the signal, the processor may receive an acknowledgement signal from the user device. Upon receiving the acknowledgement signal, the processor establishes a secured connection with the user device. The processor may receive a signal at the communication module from the user device. The processor may further automatically determine the origin of the signal. The processor communicatively connects the communication module to the user device. Then the processor is operable to send and/or receive a message to and/or from the user device. The signals received by the communication module may be analyzed to identify the origin of the signal to determine the location of the user device.

In an embodiment, the system is enabled for bidirectional communication. The system or vehicle transmits a signal and then receives a signal/communication from an external device. As a first step, a data link between the vehicle and the external device is set up in order to permit data to be exchanged between the vehicle and the external device in the form of a bidirectional communication. This can take place, for example, via a radio link or a data cable. It is therefore possible for the external device to receive data from the vehicle or for the vehicle to request data from the external device. In an embodiment, bidirectional communication comprises the means for data acquisitions and are designed to exchange data bidirectionally with one another. In addition, at least the vehicle comprises the logical means for gathering the data and arranging it to a certain protocol based on the receiving entity's protocol. Initially, a data link for bidirectional communication is set up. The vehicle and the external device can communicate with one another via this data link and therefore request or exchange data, wherein the data link can be implemented, for example, as a cable link or radio link. Bidirectional communication has various advantages as described herein. In various embodiments, data is communicated and transferred at a suitable time interval, including, for example, 200 millisecond (ms) intervals, 100 ms intervals, 50 ms intervals, 20 ms intervals, 10 ms intervals, or even more frequent and/or in real-time or near real-time, in order to allow a vehicle to respond to, or otherwise react to, data. Bidirectional communication may be used to facilitate data exchange.

According to an embodiment, the communication module supports a communication protocol, wherein the communication protocol comprises at least one of a Advanced Message Queuing Protocol (AMQP), Message Queuing Telemetry Transport (MQTT) protocol, Simple (or Streaming) Text Oriented Message Protocol (STOMP), Zigbee protocol, Unified Diagnostic Services (UDS) protocol, Open Diagnostic eXchange format (ODX) protocol, Diagnostics Over Internet Protocol (DoIP), On-Board Diagnostics (OBD) protocol, and a predefined protocol standard.

In an embodiment, the system may comprise a cyber security module. In one aspect, a secure communication management (SCM) computer device, for providing secure data connections, is provided. The SCM computer device comprises a processor in communication with memory. The processor is programmed to receive, from a first device, a first data message. The first data message is in a standardized data format. The processor is also programmed to analyze the first data message for potential cyber security threats. If the determination is that the first data message does not contain a cyber security threat, the processor is further programmed to convert the first data message into a first data format associated with the vehicle environment and transmit the converted first data message to the vehicle system using a first communication protocol associated with the vehicle system. According to an embodiment, secure authentication for data transmissions comprises: provisioning a hardware-based security engine (HSE) located in communications system, said HSE having been manufactured in a secure environment and certified in said secure environment as part of an approved network; performing asynchronous authentication, validation and encryption of data using said HSE; storing user permissions data and connection status data in an access control list used to define allowable data communications paths of said approved network; enabling communications of the communications system with other computing system subjects to said access control list; performing asynchronous validation and encryption of data using security engine; including identifying a user device (UD) that incorporates credentials embodied in hardware using a hardware-based module provisioned with one or more security aspects for securing the system.

Road deformity detection module 110: Vehicles utilize advanced algorithms for road deformity estimation, focusing on road deformity characteristics. These algorithms integrate data from camera-based sensors and information from a database on the Cloud and other authorities.

Detecting a road deformity ahead of time (from a distance before the vehicle actually encounters the deformity) and allowing the vehicle to strategize navigation involves the integration of advanced sensing and communication technologies. High-resolution cameras and LIDAR sensors continuously scan the road surface ahead, identifying irregularities such as bumps, potholes, and cracks. These sensors create detailed, real-time 3D maps of the road, highlighting any deformities. Alternatively, or additionally, vehicles can utilize V2X (vehicle-to-everything) communication systems to receive data from other vehicles and infrastructure about upcoming road conditions and/or use Cloud services or authority databases (such as road maintenance database, road construction database) information. This information is processed by the vehicle's onboard computer, which assesses the size, depth, and location of the deformity. The system then calculates an optimal approach, adjusting speed and trajectory to minimize impact and maintain safety. Advanced driver assistance systems (ADAS) can further assist by providing visual and auditory alerts to the driver, or in autonomous vehicles, by automatically executing the planned navigation strategy. This proactive approach ensures smooth and safe travel over or around road deformities.

Scanning Technologies involved may be using high-resolution cameras, which are mounted on the vehicle, to continuously capture images of the road surface. They provide real-time visual data for identifying visible irregularities such as cracks, potholes, and bumps.

Scanning Technologies involved may be using LIDAR (Light Detection and Ranging) sensors that emit laser pulses to create high-resolution 3D maps of the road surface. By measuring the time, it takes for the laser to return after hitting the road, LIDAR constructs precise profiles of road deformities, including their height and depth. Radar can penetrate fog, dust, and other environmental conditions that may impair vision-based systems. RADAR sensors complement cameras and LIDARs for detecting changes in the road surface profile.

Computer vision algorithms analyze data from high-resolution cameras using image recognition and analysis techniques. Convolutional Neural Networks (CNNs) are trained to recognize patterns and features associated with road deformities. These networks can classify and quantify various types of surface damage. AI algorithms process LIDAR data to generate detailed 3D maps and point clouds of the road surface. Machine learning models analyze these point clouds to detect irregularities, calculating precise dimensions and locations. AI techniques combine data from multiple sensors (cameras, LIDAR, radar) using data fusion techniques to enhance the accuracy and reliability of detection. Data fusion algorithms integrate different types of data to create a comprehensive understanding of road conditions.

In an embodiment, AI models can predict the presence of road deformities by analyzing historical data and patterns. For example, recurrent neural networks (RNNs) or long short-term memory (LSTM) networks can use past data to forecast potential road deformities.

In an embodiment, semantic segmentation technique is used which involves partitioning images into segments to identify and classify each pixel that corresponds to a specific part of the road deformity. Deep learning models like U-Net are commonly used for this purpose.

In another embodiment, unsupervised learning models, such as autoencoders are used to detect anomalies in road surfaces by learning the normal patterns and identifying deviations that indicate deformities.

According to an embodiment of the method, the road deformity comprises a speed bump and wherein the characteristic comprises one or more of a height of the speed bump, a width of the speed bump, a spread of the speed bump. According to an embodiment of the method, the road deformity comprises a pothole and wherein the characteristic comprises one or more of a depth of the pothole, a width of the pothole.

According to an embodiment of the system, the road deformity comprises a speed bump and wherein the characteristic comprises one or more of a height of the speed bump, a width of the speed bump, a spread of the speed bump. According to an embodiment of the system, the road deformity comprises a pothole and wherein the characteristic comprises one or more of a depth of the pothole, a width of the pothole.

According to an embodiment of the system, the message comprises one or more information on the road deformity, characteristics of the road deformity, and adjusted parameter information of the functionality of the vehicle. According to an embodiment of the system, the system further determines a route on which the vehicle is traveling and determines the road deformity that is present on the route, via cloud information.

According to an embodiment of the system, the road deformity comprises a speed bump, wherein the speed bump characteristic comprises one or more of a height of the speed bump, a width of the speed bump, a spread of the speed bump. According to an embodiment of the system, the road deformity comprises a pothole, wherein the characteristic comprises one or more of a depth of the pothole, a width of the pothole.

For the detection of road deformities such as speed bumps and potholes, vehicles may utilize advanced sensor technologies and vehicle-to-vehicle (V2V) communication to assess the reactions of other vehicles in their vicinity. While the height of a speed bump can be estimated using onboard sensors like LIDAR, radar, and cameras, determining the depth of a pothole poses a greater challenge until the vehicle is very close. By observing the responses of preceding or leading vehicles to these deformities, a more accurate estimation can be achieved.

In an embodiment, when a vehicle in front encounters a pothole, its reaction, such as sudden deceleration, a bounce, or an abrupt change in its suspension position, is detected by its sensors. Accelerometers and gyroscopes within the vehicle can also measure changes in the pitch and roll, providing further data on how the vehicle's dynamics change when encountering the deformity. This data is then processed using machine learning algorithms to identify patterns and correlate specific reactions with certain types and depths of road deformities. Additionally, V2V communication allows vehicles to share information about road conditions in real-time with following vehicles. When a vehicle encounters a pothole, it can transmit data regarding its location, the severity of the impact, and its own response to other nearby vehicles. This shared information enables following vehicles to anticipate the deformity and adjust their speed and suspension settings accordingly before encountering it directly.

In an embodiment, the following vehicle can detect the depth of a pothole by closely observing the behavior of the leading vehicle using advanced sensor systems. These sensors, including high-resolution cameras, LIDAR, and radar, continuously monitor the leading vehicle's movement and dynamics. When the leading vehicle encounters a pothole, the following vehicle's sensors can detect specific visual and kinematic cues, such as the vertical motion of the leading vehicle's wheels, the compression and rebound of its suspension, and any sudden changes in speed or direction. These sensors detect changes in the movement and dynamics of the leading vehicle, such as sudden deceleration, vertical displacement, or lateral movements. By analyzing these cues, the following vehicle can infer the presence and severity of the pothole. For instance, a significant drop in the leading vehicle's chassis followed by an upward bounce indicates a deep pothole. Advanced algorithms in the following vehicle process this sensor data in real-time, comparing it against known patterns of vehicle responses to various road deformities. This analysis enables the following vehicle to estimate the depth of the pothole and make appropriate adjustments, such as reducing speed or modifying suspension settings, to navigate the road deformity safely. This sensor-based observation and analysis approach provides a viable method for detecting pothole depth, ensuring proactive and adaptive driving responses even when direct V2V communication is unavailable.

Vehicle State Detection Module 112: Detecting the vehicle state involves the use of sensors, data analytics, and machine learning algorithms. These technologies work together to gather and analyze data about the vehicle's characteristics and current conditions.

Various sensors are used in data collection. For example, accelerometers and gyroscopes measure vehicle dynamics such as acceleration, deceleration, and tilt angles. Global Positioning System (GPS) and Inertial Measurement Units (IMUs) provide precise location data and detect movements and orientation. On-Board Diagnostics (OBD-II) Port accesses vehicle data such as engine status, speed, fuel levels, and error codes. LIDAR and Cameras monitor the road surface and surroundings, detecting obstacles and road conditions. Tire Pressure Monitoring Systems (TPMS) monitor tire pressure and temperature to assess tire health and grip.

In an embodiment, the system processes and analyzes the data collected from the sensors. The system combines data from multiple sensors to create a comprehensive understanding of the vehicle's state using sensor fusion techniques. Algorithms such as Kalman filters are used for integrating sensor data. Then, Machine Learning (ML) models analyze data to detect anomalies and predict vehicle behavior. For example, Support Vector Machines (SVM) or Random Forests can classify driving conditions and vehicle states.

In an embodiment, a Vehicle Climate Module in vehicles is a module designed to collect, analyze, and utilize real-time climate data. This module integrates data from onboard sensors, external weather services, GPS, mapping systems, and V2X communication. Onboard sensors continuously monitor immediate environmental conditions such as temperature, humidity, precipitation, and light levels, while the vehicle's GPS and mapping systems provide location and route information. This data may be sent to a database on the Cloud, and further the module retrieves real-time weather updates through weather Application Program Interface (APIs), including localized weather data relevant to the vehicle's path. V2X communication facilitates the exchange of weather updates and warnings from other vehicles and infrastructure.

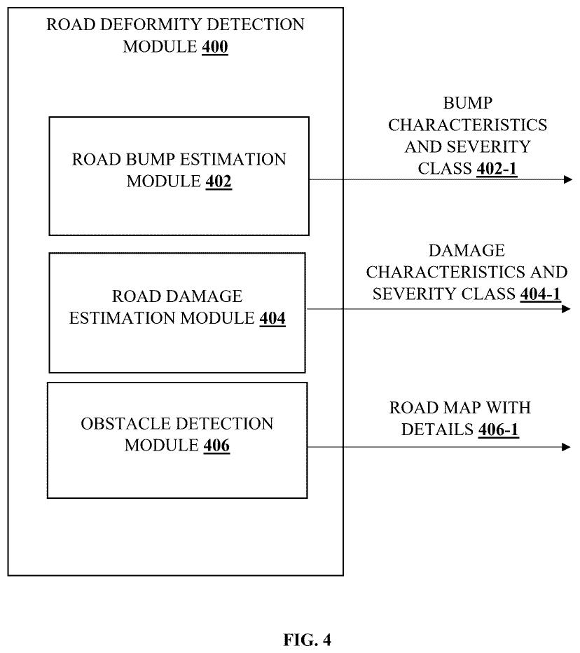

FIG. 4 shows the road deformity detection module 400 and its components according to an embodiment. In an embodiment, road deformity comprises one or more road bumps, road damage, and obstructions on the road. Detecting road bumps, road damage, and road obstructions before a vehicle encounters them involves an integrated approach using various data sources and technologies to detect and determine the characteristics of the road deformity. This process can be divided into three modules: road bump detection, road damage detection, and road obstruction detection. Each module leverages historical data, crowdsourced data, and data from road authorities, alongside real-time sensor inputs.

Road Bump Estimation Module 402 considers historical data, crowdsourced data, data from road authorities and real-time detection.

Historical data input may be considered from databases of known bumps, vehicle telemetry data, and crowdsourced data. The system considers historical data from previous scans and reports that are maintained in a database of known speed bumps. In an embodiment, machine learning models can analyze this data to predict the locations of new speed bumps based on patterns in road design and urban planning. Analysis of historical vehicle telemetry data from multiple vehicles that have encountered speed bumps can reveal consistent patterns in suspension compression and acceleration changes that indicate the presence of speed bumps. The system may further use crowdsourced data from mobile applications where drivers report speed bumps. Apps like Waze® and Google Maps® can aggregate user reports to create a real-time map of speed bumps. The system may consider social media and public reports to analyze data from social media and public reporting platforms where users share information about road conditions, including speed bumps.

The system may further consider data from road authorities, such as infrastructure Data to access data from local road authorities and municipalities regarding the installation and maintenance of speed bumps. This data includes location, size, and type of speed bumps. In an embodiment, the system may scan logs of scheduled road maintenance and updates to anticipate the installation of new speed bumps.

The system further considers Real-Time Detection of speed bumps using LIDAR and Camera Systems where Vehicles equipped with LIDAR and high-resolution cameras can scan the road surface ahead in real-time, detecting the presence and dimensions of speed bumps. Computer vision algorithms, such as convolutional neural networks (CNNs), analyze visual data to identify and classify speed bumps. Radar Systems may complement LIDAR and cameras by providing additional data on the road surface profile, especially in adverse weather conditions.

The output of the road bump estimation module 402 comprises bump characteristics and severity class 402-1. The severity class may be based on the impact it would have on the vehicle.

Bump characteristics comprise: height of the bump which is the vertical measurement from the road surface to the top of the bump, width of the bump which is the horizontal measurement across the bump, length of the bump which is the distance the bump extends along the road, shape of the bump which is the geometric profile of the bump (e.g., rounded, flat-topped), and material of the bump which is the composition of the bump (e.g., asphalt, rubber).

Severity Classification comprises classifying the bump as one of:
Minor: Low height bumps that require minimal speed adjustment.
Moderate: Bumps of medium height that necessitate moderate speed reduction and possible suspension adjustment.
Severe: High or sharp bumps that require significant speed reduction and careful navigation to avoid damage.

In an embodiment, the severity class may be classified as low to high or between a range, such as 0-1; 0-10; 0-100, based on a range assigned to a category, for example 0-2 being low, 3-7 being medium, and 8-10 being high. Severity class may be graded into more than three levels according to an embodiment.

Road Damage Estimation Module 404 considers historical data, crowdsourced data, data from road authorities and real-time detection. Historical data comprises damaged-road records where the road damage, including pothole reports, cracks, and surface wear are logged or maintained in a record. Machine learning models can analyze this data to predict potential future damage based on traffic patterns, weather conditions, and road age. Further, satellite and aerial imagery can help identify areas prone to road damage, providing a macroscopic view of road conditions over time. Additionally, and alternatively, crowdsourced data, such as driver reports which collect data from drivers reporting road damage via mobile apps and platforms is aggregated to highlight frequently reported areas of concern. In an embodiment, crowdsourced dashcam footage is analyzed using computer vision algorithms to detect road damage. Dashcam footage can provide a continuous stream of real-time data from multiple vehicles.

In an embodiment, the road damage estimation module 404 considers data from road authorities comprising maintenance records to access data on past road maintenance and repairs from local road authorities to help identify roads that may be due for maintenance or are currently under repair. In an embodiment, the system utilizes pavement condition index (PCI) data from road authorities who rate the condition of road surfaces based on regular inspections.

In an embodiment, the road damage estimation module 404 considers real-time data from in-vehicle sensors. Sensors like accelerometers and gyroscopes may be used to detect sudden changes in vehicle dynamics indicative of road damage. For example, a sharp vertical acceleration may indicate a pothole. LIDAR and Camera Systems may continuously or adaptively scan the road surface for cracks, potholes, and other types of damage. Image processing algorithms analyze the data to identify and quantify damage. Infrared Sensors may be used to detect subsurface damage that may not be visible to cameras, such as moisture accumulation leading to pothole formation.

Road damage estimation module 404 output may comprise damage characteristics and severity class 404-1. Damage characteristics include damage type that classifies the damage (e.g., pothole, crack, rut, depression), damage dimensions such as length, width, and depth of the damage, damage surface condition such as texture and integrity of the damaged area, age of damage which is an estimated time since the damage occurred.

Road damage estimation module 404 output may comprise severity classification as:
Minor: Small cracks or shallow potholes that pose minimal risk and require minimal speed adjustment.
Moderate: Larger cracks or medium-sized potholes that require caution that necessitate moderate speed reduction and possible suspension adjustment.
Severe: Deep potholes, large ruts, or extensive surface damage that pose significant risk and require immediate attention that require significant speed reduction and careful navigation to avoid damage to the navigating vehicle.

In an embodiment, the severity class may be classified as low to high or between a range such as 0-1, 0-10, 0-100 based on a range assigned to a category, for example 0-2 being low, 3-7 being medium, and 8-10 being high. Severity class may be graded into more than three levels according to an embodiment.

Road obstacle detection module 406 considers historical data, crowdsourced data, data from road authorities and real-time detection.

In an embodiment, historical data comprises obstruction records that analyze historical data on road obstructions such as fallen trees, construction barriers, and debris. Predictive models can use this data to anticipate likely locations and times for future obstructions and traffic incident reports that utilize historical traffic incident data to identify areas with frequent obstructions due to accidents or other events.

Crowdsourced data comprises driver alerts which collect real-time reports from drivers about road obstructions using mobile apps and social media platforms. Crowdsourced data provides timely information on unexpected obstructions, and Connected Vehicle Data from connected vehicles shares information about obstructions encountered on their routes. Vehicle-to-vehicle (V2V) communication can quickly disseminate obstruction data.

Data from Road Authorities comprises construction and maintenance notices that access information from road authorities on scheduled construction and maintenance activities that may cause temporary obstructions; and Emergency Services Data that utilize data from emergency services on incidents causing road obstructions, such as accidents or natural disasters.

Real-Time Detection comprises using data from camera and LIDAR Systems where forward-facing cameras and LIDAR sensors are used to detect objects obstructing the roadway. Object detection algorithms, such as YOLO (You Only Look Once), analyze the sensor data to identify and classify obstructions. Real-Time Detection may further use radar systems to provide additional detection capability, especially in poor visibility conditions, by identifying large objects or obstacles in the vehicle's path.

Road obstacle detection module 406 provides an output comprising a road map with details 406-1. The details may comprise obstruction characteristics which include type of obstruction which is obtained from classification of the obstruction (e.g., fallen tree, debris, construction barriers); size of obstruction where dimensions of the obstruction are detailed; material of the obstruction where composition of the obstruction (e.g., wood, metal, plastic) are detailed; mobility characteristics of the obstacles where details are provided on whether the obstruction is fixed or can be moved.

Road obstacle detection module 406 provides an output with severity classification where small obstructions that can be easily navigated around are classified as minor, larger obstructions requiring significant maneuvering as moderate and major obstructions that block the road and require stopping or detouring as severe. In an embodiment, the severity class may be classified as low to high or between a range such as 0-1; 0-10; 0-100 based on a range assigned to a category, for example 0-2 being low, 3-7 being medium, and 8-10 being high. Severity class may be graded into more than three levels according to an embodiment.

The system may further provide a road map with details comprising location providing GPS coordinates of the road deformity such as (bump, damage, obstruction etc.), extent of road deformity, repair status, context providing surrounding road conditions and proximity to other road deformities or intersections along with possible alternate routes, and notification providing alerts for drivers approaching the bump, including recommended actions (e.g., reduce speed, required suspension height etc.), and historical data comprising past incidents of road deformities in the same location. It may further comprise a time stamp of each deformity based on when it was first detected. In an embodiment, a notification is provided comprising alerts for drivers with recommended actions (e.g., detour, stop).

When a vehicle encounters a road deformity, the data is processed using algorithms that classify the road deformity based on predefined thresholds for size, height, steepness, and spread and provide an output on deformity characteristics and severity class. Notification to the driver about detected road bumps may be provided according to an embodiment.

According to an embodiment of the method, the parameter comprises one or more of a stiffness of a suspension system, a height of the suspension system, a mode of the vehicle, a speed of the vehicle. According to an embodiment of the method, the current vehicle state comprises vehicle load.

According to an embodiment of the system, the parameter comprises one or more of a stiffness of a suspension system, a height of the suspension system, a mode of the vehicle, a speed of the vehicle. According to an embodiment of the method, the current vehicle state comprises a load in the vehicle.

According to an embodiment of the system, the parameter is adjusted by sending a control signal by the vehicle to a subsystem of the vehicle. According to an embodiment of the system, the mode of the vehicle comprises one of a sports mode, an eco-mode, off-road mode, a comfort mode.

According to an embodiment of the system, the current vehicle state comprises a load in the vehicle or vehicle load.

Occupant State Detection Module 114: Detecting the occupant state involves the use of sensors, data analytics, and machine learning algorithms. These technologies work together to gather and analyze data about the state of the one or more occupants including the driver's state. Sensors and Monitoring Systems, comprising In-Cabin Cameras monitor occupant activities, such as whether they are looking at the road, using a phone, or resting. Further, wearable devices may be used to measure physiological parameters like heart rate, skin temperature, and activity levels to assess comfort and alertness, seat sensors may be used to detect occupant posture, weight distribution, and seat belt usage. Environmental Sensors may be used to monitor cabin temperature, humidity, and air quality to assess comfort levels.

The data collected from one or more sensors of the vehicle is then processed and analyzed. Computer vision algorithms are used to analyze facial expressions and determine the occupant's emotional state for facial recognition and emotion detection. Convolutional Neural Networks (CNNs) may be used for this purpose. Machine learning models, such as Recurrent Neural Networks (RNNs), analyze data from in-cabin cameras and wearable devices to determine the occupant's activities. Further data from seat sensors and environmental sensors may be combined with occupant activity to assess comfort levels. This involves multi-factor analysis using algorithms like Principal Component Analysis (PCA) or clustering techniques.

According to an embodiment of the system, the system further comprises determining the current state of the occupant using a camera-based sensor and one or more machine learning models by monitoring an interior of the vehicle. According to an embodiment of the system, the current state of the occupant is one of sleeping, eating, driving, sitting, talking, reading, using mobile, and listening to a device.

According to an embodiment of the system, the current state of the occupant comprises one of sleeping, eating, driving, sitting, talking, reading, using mobile, and listening to a device. According to an embodiment of the system, the occupant is one of a child, a senior person, an injured person, a pregnant person, and a differently abled person.

According to an embodiment of the system, the comfort level is measured via one or more posture analysis, and movement of the occupant due to driving.

Vehicle Functionality Control and/or Recommendation module 116: The AI system processes the sensor data in real-time to assess the nature and severity of the detected deformity. Based on the analysis, the system calculates an optimal path around or over the deformity. This involves adjusting the vehicle's speed, steering angle, and suspension settings to ensure a smooth and safe passage.

For semi-autonomous vehicles, the system provides visual and auditory alerts to the driver, suggesting adjustments in speed and steering.

In fully autonomous vehicles, the AI system may take control and execute the planned navigation strategy, ensuring minimal impact from the deformity.

Decision-Making Process for Navigating a Speed Bump involves detecting road deformity to be encountered ahead of time, analyzing the vehicle state, analyzing the occupants state, and suggesting a navigation strategy and accordingly adjusting a functionality of the vehicle. In an embodiment, the system further considers the current weather conditions in the analysis and to determine the navigation strategies. For example, a high speed while approaching a speed bump during normal weather conditions may have a different outcome as compared to a day with heavy rain or snow.

Detection of Road deformity: Using LIDAR, camera-based sensors, radar etc., the system detects the presence and dimensions of a road deformity ahead. It employs image processing and object detection techniques such as deep learning models like YOLO (You Only Look Once) or Faster R-CNN to identify and measure the road deformity from the sensor data.

Assessment of Vehicle State: The system then proceeds to evaluate current speed, suspension status, tire condition, and vehicle load along with known vehicle characteristics such as vehicle's characteristics and features to determine how the vehicle will respond to the speed bump.

Assessment of Occupant State: In this step, the system assesses what activity that the occupant is currently doing (e.g., reading, resting, sleeping, driving) and their comfort level either preferred or determined based on the activity to determine how best to navigate the bump without causing discomfort or distraction.

Navigation Strategy and Adjustment: Algorithms like Model Predictive Control (MPC) or Reinforcement Learning (RL) may be used for speed and trajectory adjustment. In an embodiment, the system adjusts the speed and steering to smoothly navigate the speed bump. For vehicles with adaptive suspension systems, algorithms further adjust the suspension stiffness and damping to minimize impact. This may involve real-time adjustments using Proportional-Integral-Derivative (PID) controllers. In an embodiment, the system provides visual and/or auditory alerts to the occupant to prepare for the speed bump.

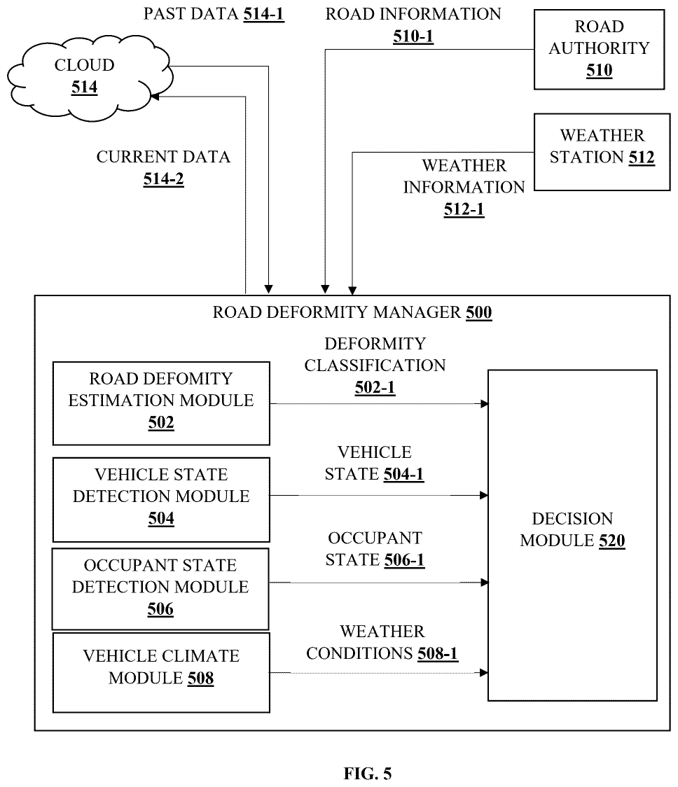

FIG. 5 shows the architecture of the system to modify the functionality of the vehicle based on a road deformity information according to an embodiment.

The architecture for the implementation comprises the data flow between the road deformity manager 500 and Cloud 514. The road deformity manager is configured to fuse/merge the information from four modules.

Road deformity estimation module 502 provides the details on deformity classification 502-1, based on deformity type, characteristics, and severity. The system may further collect road information 510-1 from road authority 510.

Vehicle state detection module 504 provides details on vehicle state 504-1 based on vehicle conditions and vehicle characteristics.

Occupant state detection module 506 provides details on occupant state 506-1 based on occupant current activity.

Vehicle climate module 508 collects vehicle ambient weather 508-1 information e.g., temperature, humidity, sunlight, etc. Further the vehicle climate module may collect weather information 512-1 from weather stations 512 for a location of interest or along a route. Weather stations 512 may also provide the weather information 512-1 or weather forecast information.

According to an embodiment of the system, the road deformity manager can be located locally in the non-transitory memory of the vehicle or on a Cloud.

All the four modules described herein provide the estimates attached to a GPS location information for the vehicle. The system of the vehicle can send the current data 514-2 comprising road deformity information, weather conditions, along with GPS location to the Cloud and/or get the previous data 514-1 comprising past data 514-1 on road deformity information and weather conditions from the Cloud 514.

Weather Data Integration: The system further comprises integrating weather data from external sources to augment the road deformity conditions. By using GPS and weather forecasts, the vehicle can adjust its functionality such as speed, steering angle, suspension height etc., based on current and predicted weather patterns.

Referring to the architecture described in FIG. 5, the system will fusion the information from four modules necessary for decision-making at decision module 520. This involves the integration of data from various sources to implement artificial intelligence/machine learning based algorithms to determine the best possible decision. The decision could involve what functions need to be adjusted, and whether a different route can be taken etc., based on the input data from the four modules.

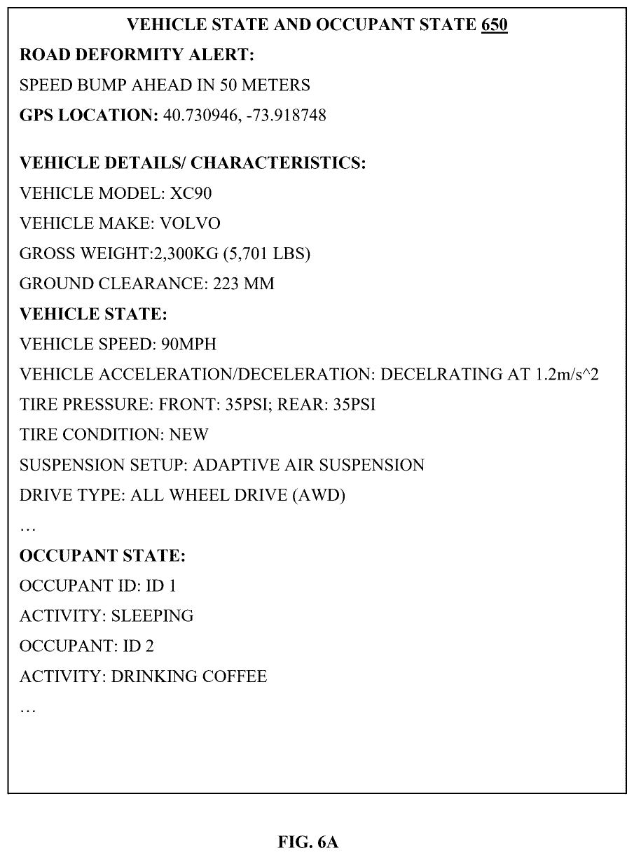

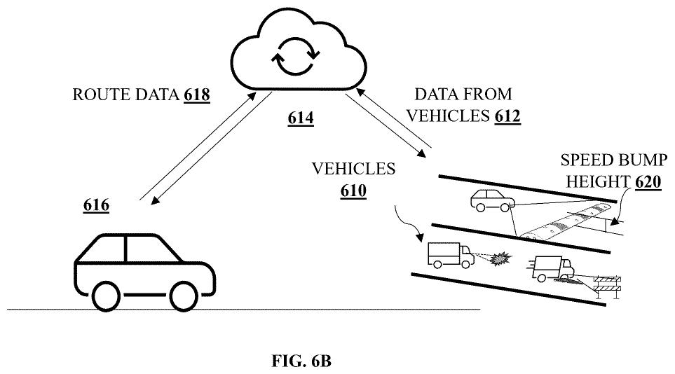

FIG. 6A shows vehicle state and occupant state parameters according to an embodiment. Vehicle details, vehicle conditions, driver conditions are gathered along with road deformity information at a geographic location. These details may be, for example, as shown in FIG. 6A and may be referred to as vehicle state and occupant state 650. It may comprise of road deformity details, distance from road deformity, characteristics of the road deformity, vehicle characteristics comprising vehicle model, vehicle make, gross weight, ground clearance etc., vehicle state comprising vehicle speed, vehicle acceleration/deceleration, tire pressure, tire conditions, suspension setup, drive type etc., and occupant state comprising identifying the number of occupants and the activity they are performing. Such information may be provided ahead of the road deformity such that there is sufficient time to change the functionality of the vehicle. Sufficient time could be in the range of seconds to minutes. For example, 2 s, 3 s, 5 s, 8 s, 10 s, 1 minute, 5 minute, 10 minutes or even before the occupant takes the route. The time could be replaced by distance, for example, 1 meter, 2 meters, 5 meters, 10 meters, etc. The road deformities may be identified during route planning and informed to the occupant. The route planning may involve i) choosing a route with minimum road deformities, ii) choosing a route to avoid road deformities of certain characteristics, for example, speed bumps of height more than 6 inches etc. iii) recommending various vehicle functionality settings and the time for activating those settings temporarily on the chosen route, for example recommending one or more adjustments in speed, steering angle, and suspension stiffness and the time when to adjust these settings.

Adjustments in vehicle functionality for navigating road deformities are influenced by various vehicle-related factors. For example, higher vehicle speeds necessitate more abrupt adjustments and increase the risk of damage or discomfort. Therefore, vehicle systems may recommend or automatically reduce speed when approaching a road deformity. The suspension system, particularly advanced types like adaptive or active suspensions, can adjust damping and stiffness in real-time to better absorb shocks and maintain stability, thus enhancing ride comfort. Tire condition also influences the road deformity navigation; tires with adequate tread depth and correct pressure levels offer better traction and shock absorption, allowing the vehicle to handle road irregularities more effectively. Vehicle load, which affects the center of gravity and suspension response, is another important factor. Heavier loads require more careful handling, and load sensors can provide real-time data to the system to then be able to adjust suspension settings and driving strategy.

The drivetrain configuration, such as front-wheel drive, rear-wheel drive, or all-wheel drive, influences how power is distributed to the wheels and how the vehicle handles road deformities. All-wheel drive systems typically offer better traction and stability, allowing for more controlled adjustments. The stiffness of the chassis and body also affects how forces are distributed during encounters with road deformities, with stiffer designs better absorbing impacts and reducing vibrations transmitted to occupants.

In an embodiment, the system of the vehicle sends a signal to vehicle dynamics control systems like Electronic Stability Control (ESC) and Traction Control System (TCS) for making real-time adjustments to braking and power distribution. Similarly, the system of the vehicle may send a signal to Advanced Driver Assistance Systems (ADAS) for automatic braking and reducing speed, when anticipating road deformity conditions.

Aerodynamic features, such as adjustable spoilers and air dams, may alter the vehicle's airflow to enhance stability and control when navigating road deformities at higher speeds. Ground clearance, or the height between the lowest part of the vehicle and the road surface, needs to remain positive especially when clearing obstacles without damage to the vehicle; vehicles with adjustable ground clearance are sent a signal to raise or lower themselves to better handle different road conditions. The braking system, including the presence of anti-lock braking systems (ABS), affects how the vehicle slows down and stops in response to road deformities, with efficient braking systems preventing skidding and ensuring controlled navigation. By considering these vehicle factors, the system of the vehicle can make informed and real-time adjustments to the vehicle's functionality, ensuring safe and comfortable navigation of road deformities. These adjustments may include altering speed, modifying suspension settings, redistributing load, and leveraging advanced driver assistance systems to maintain optimal performance and occupant safety.

Adjustments in vehicle functionality for navigating road deformities are influenced by various occupant-related factors. The state and activity of vehicle occupants influence the adjustments made to vehicle functionality when anticipating road deformities. The system would signal the vehicles equipped with advanced driver assistance systems (ADAS) and adaptive suspension technologies to adjust the functionality of the vehicle based on real-time data about occupant conditions to enhance safety and comfort.

Firstly, the occupant's state, including their position, posture, and engagement level are considered. For example, if sensors detect that an occupant is seated upright and alert, the vehicle may make less aggressive vehicle functionality adjustments, assuming the alert occupant is aware of the situation. If sensors detect that an occupant is reclined or appears distracted or asleep, the vehicle system may make aggressive vehicle functionality adjustments to smooth out any sudden impacts, this ensures that any sudden changes in vehicle dynamics do not startle or discomfort the occupant.

Secondly, the specific activities of occupants that influence vehicle adjustments are considered. For example, if the system detects that an occupant is engaged in a delicate activity, such as drinking a hot beverage, reading, or using a laptop, the vehicle may opt for smoother, more gradual adjustments to suspension and speed to avoid disruptions. In contrast, if all occupants are securely seated and not engaged in activities requiring high stability, the vehicle may prioritize more direct adjustments to maintain optimal control over the deformity. To achieve these tailored adjustments, vehicles use a combination of in-cabin sensors, including cameras and pressure sensors, to monitor occupant states and activities. The data collected is processed by the vehicle's electronic control unit, which then determines the most appropriate suspension settings, speed adjustments, and trajectory modifications. For instance, when approaching a speed bump, if an occupant is detected to be using a laptop on a foldable table, the vehicle's suspension system might engage a softer damping mode to reduce jostling. Simultaneously, speed can be adjusted more gradually to ensure a smoother ride. Conversely, if occupants are simply seated and not engaged in any specific activities, the vehicle might execute firmer suspension adjustments and quicker speed reductions to maintain control and stability.

By considering the vehicle state, vehicle characteristics, state and activity of occupants, the vehicle can tailor its responses to ensure both the safety and comfort of its passengers.

The description of factors or the list provided in FIG. 6A serves as an illustrative example and is not comprehensive. The factors that influence the navigation of the road deformity are to be considered. Therefore, any vehicle state or occupant state that affects the decision on modifying a functionality of the vehicle due to road deformity should be considered as part of the list, even if it is not explicitly mentioned in FIG. 6A.

According to an embodiment of the system, the system further comprises a vehicle detail, wherein the vehicle detail comprises one or more of a brand, model, a make, and a weight class category of the vehicle. According to an embodiment of the system, the system further considers a vehicle operating detail, wherein the vehicle operating detail comprises one or more of a speed, an acceleration or deceleration, a steering wheel position, and a brake force. According to an embodiment of the system, the system further considers driver behavior data, wherein the driver behavior data comprises an acceleration pattern, a braking pattern, a reaction time, and a steering behavior. According to an embodiment of the system, the system further comprises a weather detail, wherein the weather details comprise real-time weather conditions at the geographic location. Weather conditions include snow, rain, dry, humid, hot, and combinations of temperature and humidity etc.

FIG. 6B shows a vehicle interacting with the Cloud to gather the crowdsourced data of a geographic location according to an embodiment. According to an embodiment of the system, one or more vehicles 610 collect data via a sensor or a component responsible for collecting specific data. The data may be specific to road deformities which are tagged to the location, for example, potholes, cracks, obstacles etc. Some of the details, for example obstacles, may also be cross verified or gathered from construction authority websites or databases.

In an embodiment, vehicles 610 may upload the data from vehicles 612 on road deformities comprising data on road bump data, road damage, pothole data along with geographic location. It may further comprise a comprehensive set on vehicle state/conditions, driving behavior, and occupant states along with the vehicle characteristics such as make, model, drive type etc., corresponding to each of these vehicles. Some of the vehicle characteristics may also be obtained based on the vehicle model from an Original Equipment Manufacturer (OEM) website or database. The data from vehicles 612 is sent to a database on Cloud 614. In an embodiment, a part of the collected information may be sent to a database on the Cloud. For example, data as shown in FIG. 6A or a sub part of the information. For example, the data may include a characteristic of the road deformity, for example speed bump height 620. Any other vehicle, such as 616 may use route data 618 to access the information corresponding to the route. The query may be via an application software installed in a smartphone or mobile. The user may query using geographic location or by connecting to a service provider or App which provides the information while at/near the geographic location. The data obtained from a database on the Cloud may include information on one or more road deformities, corresponding weather conditions, vehicle conditions, and occupant conditions. The user may then use the information for rerouting or selecting a route with minimal obstacles/road bumps in vehicle 616. The system within the vehicle may comprise a processor comprising one or more machine learning models configured to filter out the data from the vehicle 612 accessed through a database on Cloud 614. In an embodiment, the Cloud may comprise of other applications which may process the data and provide the analytics. The filtering method may be a rule-based system or AI/ML cluster-based method based on various vehicle characteristics, vehicle state, occupant state, and deformity characteristics.

In an embodiment, Artificial Intelligence (AI) and Machine Learning (ML) methods may be used to improve the decision making on adjusting the functionality of the vehicle by integrating and analyzing various factors or input parameters such as road deformity information, vehicle state, occupant state, and weather conditions, as explained herein. One effective approach involves the use of supervised learning algorithms, such as decision trees, random forests, and gradient boosting machines, which can be trained on historical data to predict vehicle functionality adjustment based on the input parameters. These algorithms can learn complex relationships between the various factors and their impact on occupant comfort and safety, enabling the system to adjust the vehicle.

In an embodiment, ensemble learning techniques, which combine the predictions of multiple models to improve accuracy, may be particularly beneficial. For instance, a random forest model can aggregate the outputs of multiple decision trees, each trained on different subsets of data, to provide a robust estimate of vehicle functionality adjustments. Gradient boosting machines can sequentially build models that correct the errors of previous models, further enhancing predictive performance.

In an embodiment, unsupervised learning methods, such as clustering algorithms, may be employed to identify patterns and anomalies in the data. For example, clustering algorithms can group similar road conditions, vehicle states, occupant states, and weather patterns, helping to find appropriate vehicle adjustments.

In an embodiment, Deep learning techniques, such as convolutional neural networks (CNNs) and recurrent neural networks (RNNs), may be utilized to process and analyze large volumes of data from various sensors and sources. CNNs can effectively handle spatial data, such as images of road deformities, while RNNs are well-suited for time-series data, such as weather patterns and probed vehicle reports over time. These neural networks can learn intricate patterns and dependencies in the data, providing predictions for vehicle functionality adjustments.

In an embodiment, reinforcement learning can be employed to continuously improve the system's performance through trial and error. By receiving feedback from real-world driving scenarios, the system can adapt and optimize its predictions over time, ensuring that it remains accurate and reliable under varying conditions.

According to an embodiment of the system, the system further considers information available on the road deformity from the cloud. According to an embodiment of the system, the system is further configured to provide an alternate route to avoid the road deformity.

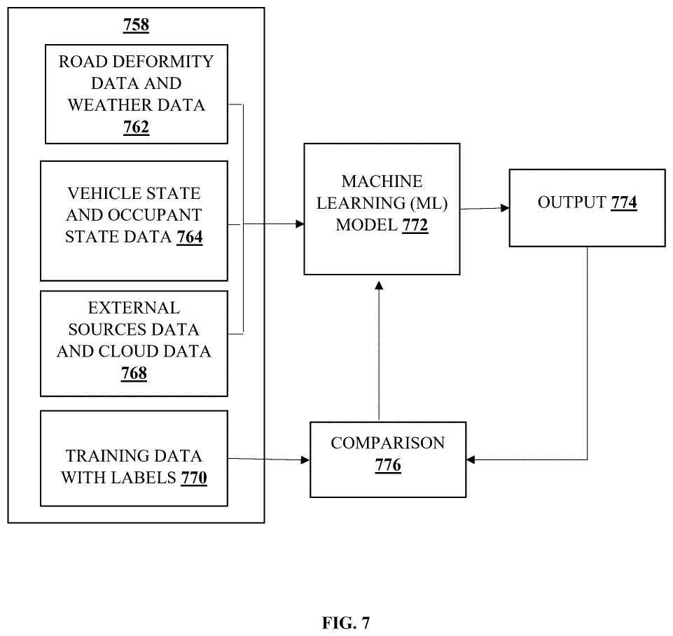

FIG. 7 shows an example block diagram for an Artificial Intelligence and Machine Learning (AI/ML) model to modify the functionality of the vehicle based on road deformity information according to an embodiment.

The machine learning model 772 may take input from road deformity data and weather data 762. It may comprise only road deformity data. It may comprise data from vehicle systems on road deformity characteristics, construction site maps, weather data sensed by the vehicle sensors etc., as explained in FIG. 4 and FIG. 5.

The training data sample may also comprise vehicle state and occupant state data 764 relating to the vehicle and the driving. This may comprise, for example, vehicle weight, speed, braking style, steering input data, driver behavior such as fatigue, vehicle characteristics, occupant activity, occupant comfort level based on activity etc., as explained in FIG. 6A.

External sources data and Cloud data 768 may comprise data derived from crowdsourcing data, from other vehicles, from weather authorities, road authorities, etc. as explained in FIG. 5 and FIG. 6B.

Any of the aforementioned types of data (e.g., road deformity data and weather data 762, vehicle state and occupant state data 764, external sources data and Cloud data 768) may correlate or form a pattern of inputs and the corresponding output 774 which is a modification to one or more functionalities of the vehicle. Correlations/patterns between inputs and outputs may be automatically learned by the machine learning model 772. In an embodiment, during training, the machine learning model 772 may process the training data sample (e.g., road deformity data and weather 762, vehicle state and occupant state data 764, external sources data and Cloud data 768) and, based on the current parameters of the machine learning model 772, predict output 774 which is a modification to one or more functionalities of the vehicle. A modification to functionalities of the vehicle comprises one or more of adjustments to speed, adjustments to steering, adjustments to braking, adjustments to damping and stiffness of an active suspension system, adjustments to power redistribution to the wheels of the vehicle, adjustments to height to increase or decrease the ground clearance, adjustments to load and its distribution, suggestions or recommendations to adjust any of the above at a predetermined time before the vehicle actually encounters the road deformity. In an embodiment, the output 774 may further comprise a rerouting or suggesting a route to avoid road deformities of certain road deformity characteristics, for example, speed bumps of height 5 inches or more, speed bumps more than 2 in the route, road under construction, road with potholes of certain depth, etc. In an embodiment, the output 774 comprises a time at which the modification must be performed to the functionality of the vehicle. For example, 5 seconds before the actual encounter of the speed bump, the speed should be reduced to 30 mph and steering angle should be set to 2 degrees.

In an embodiment, the real-time sensor data may be processed using one or more machine learning models 772, trained and based on similar types of data to correctly predict an adjustment of the vehicle functionality for a given data. For example, comparison 776 may be based on a loss function that measures a difference between the predicted/detected output and the training data with labels 770. Based on the comparison at 776 or the corresponding output of the loss function, a training algorithm may update the parameters of the machine learning model 772, with the objective of minimizing the differences or loss between subsequent predicted output 774 and the corresponding labels 770. By iteratively training in this manner, the machine learning model 772 may “learn” from the different training data samples and become better at predicting output 774. In an embodiment, the machine learning model 772 is trained using a data class which is specific to a vehicle for which the model is predicting adjustments, that is, if the vehicle is an Sports Utility Vehicle (SUV), the data from a database on the Cloud is considered for an SUV of similar weight and speed class, under similar driving conditions, weather conditions, load conditions, vehicle states, and occupant states. In an embodiment, the machine learning model 772 is trained using data which is general to the vehicle types and is used for predicting the output 774 which is a modification to one or more functionalities of the vehicle. In an embodiment, each data element from the road deformity data and weather data 762, vehicle state and occupant state data 764, external sources data and Cloud data 768 may be given weights provided as inputs to the AI/ML system.

Through training, the machine learning model 772 may learn to identify predictive and non-predictive features and apply the appropriate weights to the features to optimize detecting accuracy and predictive accuracy of the machine learning model 772. In embodiments where supervised learning is used and each training data sample 758 has a label forming training data with labels 770, the training algorithm may iteratively process each training data sample 758 (e.g., road deformity data and weather 762, vehicle state and occupant state data 764, external sources data and Cloud data 768) and generate a predicted output 774 which is a modification to one or more functionalities of the vehicle. Based on the comparison 776 results, the training algorithm may adjust machine learning model 772 parameters/configurations (e.g., weights) accordingly to minimize the differences between the generated predicted output 774 and the corresponding labels 770. Any suitable machine learning model and training algorithm may be used, including, e.g., neural networks, decision trees, clustering algorithms, and any other suitable machine learning techniques. Once trained, the machine learning model 772 may take input data and predict output 774 which is a modification to one or more functionalities of the vehicle. In an embodiment, the machine learning model, 772 is an artificial neural networks (ANN) model.

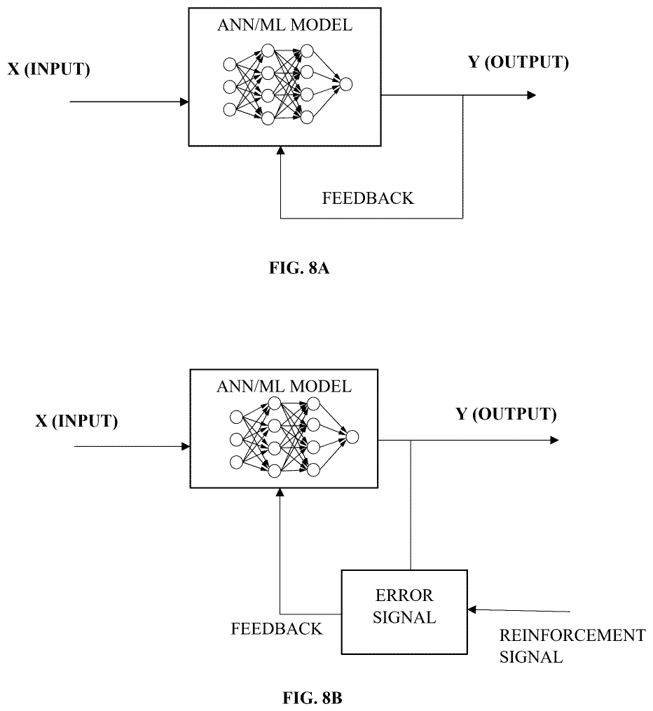

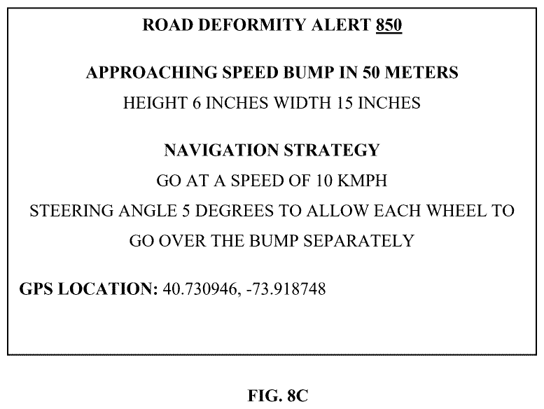

FIG. 8A shows a structure of the neural network/machine learning model with a feedback loop according to an embodiment. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. Input data comprises road deformity data and weather 762, vehicle state and occupant state data 764, external sources data and Cloud data 768, and output data 774 may comprise which is a modification to one or more functionalities of the vehicle, recommendation to the driver, or a time at which a modification to one or more functionalities of the vehicle is to be performed. The model may learn from the data. Learning can be supervised learning and/or unsupervised learning and may be based on different scenarios and with different datasets. Supervised learning comprises logic which uses at least one of a decision tree, logistic regression, and support vector machines. Unsupervised learning comprises logic which uses at least one of a k-means clustering, a hierarchical clustering, a hidden Markov model, and an apriori algorithm. The output layer may be a modification to one or more functionalities of the vehicle, a recommendation to the driver for modification to one or more functionalities of the vehicle, a recommendation on a time at which a modification to one or more functionalities of the vehicle is to be performed, or a time at which a modification to one or more functionalities of the vehicle is to be performed automatically based on the inputs which may be road deformity data and weather 762, vehicle state and occupant state data 764, external sources data and Cloud data 768, and a previous output 774.

In an embodiment, ANNs may be a Deep-Neural Network (DNN), which is a multilayer tandem neural network comprising Artificial Neural Networks (ANN), Convolution Neural Networks (CNN) and Recurrent Neural Networks (RNN) that can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback. The variations of weights in the hidden layer(s) will be adjusted to fit the expected outputs better while training the model. This will allow the model to provide results with far fewer mistakes. The neural network is featured with the feedback loop to adjust the system output dynamically as it learns from the new data. In machine backpropagation, propagation and feedback loops are used to train an Artificial Intelligence (AI) model and continuously improve it upon usage. As the incoming data that the model receives increases, there are more opportunities for the model to learn from the data. The feedback loops, or backpropagation algorithms, identify inconsistencies and feed the corrected information back into the model as an input. Even though the AI/ML model is trained well, with large sets of labeled data and concepts, after a while the models' performance may decline while adding new, unlabeled input due to many reasons which include, but not limited to, concept drift, recall precision degradation due to drifting away from true positives, and data drift over time. A feedback loop in the model keeps the AI results accurate and ensures that the model maintains its performance and improvement, even when new unlabeled data is assimilated. A feedback loop refers to the process by which an AI model's predicted output is reused to train new versions of the model.

Initially, when the AI/ML model is trained, a few labeled samples comprising both positive and negative examples of the concepts (e.g., different types of road bumps, weather conditions, road damage information, construction details etc. for different vehicle weight classes under similar road conditions, driving behavior, occupant state vehicle state, etc.) are used that are meant for the model to learn how and what adjustments need to be performed in the vehicle functions. Afterward, the model is tested using unlabeled data. By using, for example, deep learning and neural networks, the model can then make predictions on whether the desired output (e.g., a modification to one or more functionalities of the vehicle, a recommendation to the driver for modification to one or more functionalities of the vehicle, a recommendation on a time at which a modification to one or more functionalities of the vehicle is to be performed, or a time at which a modification to one or more functionalities of the vehicle is to be performed automatically etc.) is in the predicted accuracy level. However, in the cases where the model returns a low score or low confidence in the functionality adjustment estimations/predictions, this input may be sent to a controller (maybe a human moderator) which verifies and, as necessary, corrects the result. The human moderator may be used only in exceptional cases. The feedback loop feeds labeled data, auto-labeled or controller-verified, back to the model dynamically and is used as training data so that the system can improve its predictions in real-time and dynamically.

FIG. 8B shows a structure of the neural network/machine learning model with reinforcement learning according to an embodiment. The network receives feedback from authorized networked environments. Though the feedback logic is like supervised learning, the feedback obtained in this case is evaluative, not instructive, which means there is no teacher as in supervised learning. After receiving the feedback, the network performs adjustments of the weights to get better predictions in the future. Machine learning techniques, like deep learning, allow models to take labeled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

Database 118: The system stores various types of data that can be stored in a database for processing, analysis, and future reference. In an embodiment, it may store the data for service providers. Data comprises raw data captured by the in-vehicle sensors, data about the vehicle and driving characteristics, geographic location, weather data, occupant state, vehicle state, estimated predictions on the vehicle functionality, actual adjustments to the functionality, and whether the adjustments were adequate (that may be collected via a survey or oral/input based feedback on the occupant's comfort and safety via a dashboard or portable device such as a mobile) etc., all these values may be stored in the database 118. The data or part of the data may be uploaded to a database on the Cloud for other vehicle system reference. The data while uploading or while downloading from a database on the Cloud may be secured using cybersecurity protocols.

Notification module 120: Notification module may notify the user of the warning related to road deformity and a recommendation on the necessary adjustments for safety of the vehicle and occupant, as well as the comfort level of the occupant. FIG. 8C shows a message that may be noted or displayed for the user according to an embodiment. The notification comprises road deformity alert 850 comprising details on an approaching road deformity, a distance to the road deformity, characteristics of the road deformity and a recommendation to adjust one or more functionalities of the vehicle. The message may be sent to an external device or may be displayed on an infotainment system according to an embodiment. The notification module is designed to deliver timely and accurate information regarding road deformity conditions and navigation strategies. This module integrates with the vehicle's onboard systems and the central AI/ML processing unit to receive real-time data on road deformity conditions, including road bumps, road damage, weather, and road construction details. Upon determining a road deformity, the module utilizes a combination of visual, auditory, and haptic feedback to alert the driver. Visual alerts may appear on the dashboard or heads-up display, prominently indicating the road deformity details and recommended navigation strategies. Auditory alerts can include warning chimes or spoken messages to ensure the driver's attention. Additionally, haptic feedback, such as vibrations through the steering wheel, can provide a tactile warning. The notification module ensures that alerts are clear and easily interpretable, providing actionable information without overwhelming the driver. By delivering these alerts promptly, the system enhances driver awareness and safety, enabling informed decisions to mitigate risks associated with road deformity. According to an embodiment, the system is configured to send alerts to a driver of the vehicle about the road deformity condition prompting the driver to take precautionary measures. According to an embodiment, the system may take the action automatically.

According to an embodiment of the system, the alert is via one or more of auditory, tactile, and visual. According to an embodiment of the system, the system is further configured to display a video showing a strategy to navigate the road deformity.

Display module 122: Display module 122, in the vehicles may be connected to the notification module 120 through the vehicle's onboard computer or electronic control unit (ECU) according to an embodiment. Any message sent to the display module by the notification module is presented to the user on the vehicle's infotainment system, displayed and/or via a speaker, or sent to a user's personal device. The connection between notification module 120 and the display module 122 is established through a communication network within the vehicle. Modern vehicles use Controller Area Network (CAN) or other communication protocols to transmit data between different electronic components, including the alert system and the display module.

Once the signal reaches the display module, it activates the appropriate visual and audible alerts to inform the users. In another embodiment, the display module may also generate pop-up alerts on the infotainment or navigation screen. Furthermore, the vehicle may be equipped with haptic feedback capabilities, the display module 122 can trigger haptic alerts, such as gentle vibrations in the seat, to provide an additional tactile cue to the user.

In an embodiment, the system comprises on-edge computing units and temporary memory. On-edge computing units refer to hardware components installed within the vehicle that are responsible for processing data locally, without relying on external servers or Cloud services. This unit typically comprises a specialized computer or microcontroller with sufficient processing power and memory to perform computations in real-time. Its function is to execute algorithms and analyze data collected by the system's sensors, cameras, and other input devices. Temporary memory, also known as volatile memory or RAM (Random Access Memory), is a type of computer memory that temporarily stores data and instructions that the CPU (Central Processing Unit) needs to access quickly. On-edge computing in the context of road deformity alert systems may be used due to its ability to process data locally on the vehicle, ensuring rapid and efficient analysis of real-time conditions. By performing computations on-edge, the system can immediately integrate data from various sensors, including road deformity conditions, weather conditions, vehicle state, and occupant state, without the latency associated with Cloud-based processing. This immediacy can be useful to provide timely alerts and can impact a driver's response to road deformity conditions. Moreover, on-edge computing enhances reliability by reducing dependence on continuous internet connectivity, which can be intermittent or unavailable in certain driving environments. It also ensures data privacy and security by keeping sensitive information within the vehicle's ecosystem. The decentralized nature of on-edge computing distributes the processing load, optimizing the system's overall performance and resilience. Consequently, on-edge computing is integral to delivering fast, reliable, and secure road deformity alerts, thereby improving driving safety and decision-making in real-time.

In some implementations, the user devices and the vehicle may be associated with a notification platform. In some implementations, one or more sensors may communicate with the user device of the driver, a vehicle control system of the vehicle, the user device of the passenger, the notification platform, and/or the like. User device comprises one or more devices capable of receiving, generating, storing, processing, and/or providing information, such as information described herein. For example, user device may comprise a mobile phone (e.g., a smart phone, a radiotelephone, etc.), a laptop computer, a tablet computer, a desktop computer, a handheld computer, a gaming device, a wearable communication device (e.g., a smart watch, a pair of smart eyeglasses, etc.), or a similar type of device. In some implementations, user devices may receive information from and/or transmit information to notification platforms and/or server devices. User device may comprise an Application Software Interface (API) that integrates with the system. In some implementations, the notification platform may be hosted in a Cloud computing environment. Notably, while implementations described herein describe notification platform as being hosted in a Cloud computing environment, in some implementations, notification platform may be non-Cloud-based (i.e., may be implemented outside of a Cloud computing environment) or may be partially Cloud-based.

In an example, if a user is driving in a parking lot, but there are a lot of speed bumps, then based on the height of the speed bump a vehicle's suspension height is adjusted. Use external devices, cameras, LIDARs, or other sensors to determine a speed bump then recommend or automatically adjust the suspension such that when the vehicle goes over the speed bump, the bottom of the vehicle is not damaged.

Further, the system will consider if the vehicle is placed in a comfort zone, like a comfort mode versus sport mode. When the speed bump is recognized as above a threshold that is going to cause a discomfort or high acceleration in vertical direction to the motion of the vehicle, the system may suggest to the driver that there is a speed bump coming, and then it may automatically make the suspension adjustments. The system further recognizes that there are one or more occupants, and it will make the adjustment based on the current load on the vehicle. Further, if one of the occupants is recognized as a baby, or somebody is sleeping, then an automatic comfort level would be set by the system based on the activity and occupant state and the adjustments would be made to the functionality of the vehicle to maintain the comfort level. In comfort mode, when the vehicle goes over the bump, it is almost seamless that the occupants are not going to feel any sudden changes in their position. If somebody is eating in the vehicle, the system would recognize it, then it is going to make the suspension much smoother and absorb the shock of a speed bump which may be high.

The system may use the imagery to inform the user where all the bumps are, for example depicting or overlaying the bumps on a Google map® or any other maps. The image may further comprise characteristics listed. For example, a color code may show all bumps of a certain threshold, say 8 inches and above, qualifying as high, in red color, medium height as orange and low height as yellow. As the vehicle approaches, it would automatically adjust the suspension based on the speed bump characteristics.

Based on an AI based method, the system would recognize the user's comfort zone settings over speed bumps along a route based on historical data i.e., from prior knowledge. In an embodiment, maps or databases may be made available based on the location.

In an embodiment, the system provides an alternate route based on a comfort setting. For example, the system may further suggest taking a first lane on a route or a different route to avoid speed bumps.

The system may tighten the suspension and raise the vehicle's height to increase the ground clearance to clear obstacles. Higher ground clearance is typically found in SUVs and off-road vehicles, allowing them to navigate obstacles like rocks, debris, and bumps more effectively, while lower ground clearance is common in sports cars and sedans, enhancing aerodynamics and handling on smooth, paved roads. When encountering a speed bump, the suspension tightness may be maintained while raising the vehicle to ensure that the vehicle clears the bump, especially for low-ground clearance vehicles. Ground clearance impacts a vehicle's performance on rough or uneven roads. This adjustment is temporary, activated just before and during the bump traversal, based on the bump's size, the vehicle's speed, and the distance to the bump. Some bumps extend for a significant portion of the vehicle's length, requiring careful navigation to prevent damage to the vehicle and its suspension. The system adjusts the suspension's tightness and height using control instructions to the adjustment system, ensuring both the front and rear wheels navigate the bump smoothly. Continuous monitoring identifies the optimal points for adjustment. On highways, where bumps are rare, the system reduces monitoring frequency to conserve battery life. In contrast, in urban areas or parking lots, where bumps are more common, the system frequently scans for obstacles. When the suspension detects an impact exceeding a certain threshold, it records the location, treating it as a potential bump or dip for future reference. This approach also considers both bumps and dips, ensuring comprehensive monitoring for various road irregularities.

Ground clearance adjustment mechanisms can be provided using one of air suspension, hydraulic suspension, and electromechanical systems, which allow for real-time changes to the vehicle's height. Air suspension systems utilize air springs, an air compressor, and a control module to inflate or deflate the air springs, thus raising or lowering the vehicle. Hydraulic systems, on the other hand, use hydraulic cylinders and a hydraulic pump to adjust fluid pressure, modifying the ride height. Electromechanical systems employ electric actuators controlled by a central unit to extend or retract, changing the ground clearance as needed. Adjustments are made temporarily for off-road driving or where road deformities exist, where increased ground clearance is needed, and for highway driving, lower clearance is used to enhance stability and fuel efficiency.

Suspension stiffness adjustment mechanisms are used for vehicle handling and comfort. Active damping systems, a common method for adjusting suspension stiffness, rely on sensors, a control unit, and actuators to modify the damping force in real-time. Sensors monitor vehicle dynamics, such as speed, acceleration, and road deformity conditions, and send data to the electronic control unit. The control unit processes this data and directs actuators within the shock absorbers to adjust the damping force, either through electromagnetic valves that regulate hydraulic fluid flow or through systems using magnetorheological fluids or piezoelectric actuators. By dynamically altering the stiffness of the suspension, these systems balance ride comfort and handling performance, adapting to smooth highways or rough terrains/roads with deformities.

According to an embodiment of the system, the parameter comprises one or more of a stiffness of a suspension system, a height of the suspension system, a mode of the vehicle, a speed of the vehicle. According to an embodiment of the system, the height of the suspension system is adjusted via one of electronically adjustable height suspension springs, adjusting air pressure in air suspension system, adjusting fluid pressure in hydraulic suspension, controlling magnetic field of magnetic shock absorbers. According to an embodiment of the system, the stiffness of the suspension system is adjusted via one of active dampers, adjusting coil overs, adjusting air pressure in air suspension system, and adjusting fluid pressure in hydraulic suspension.

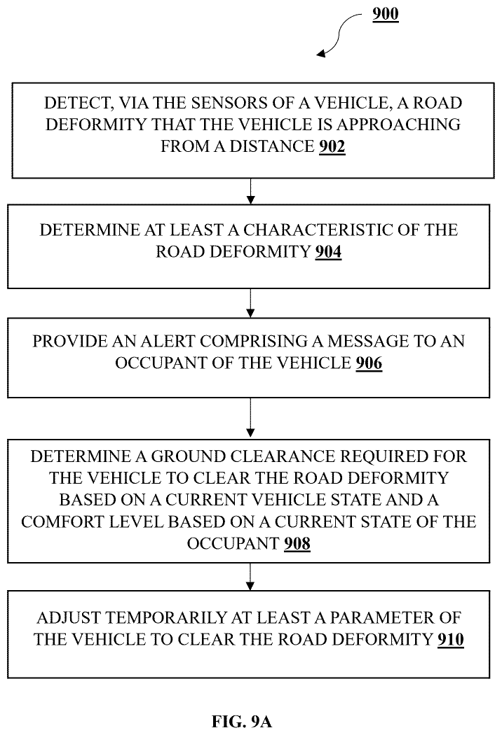

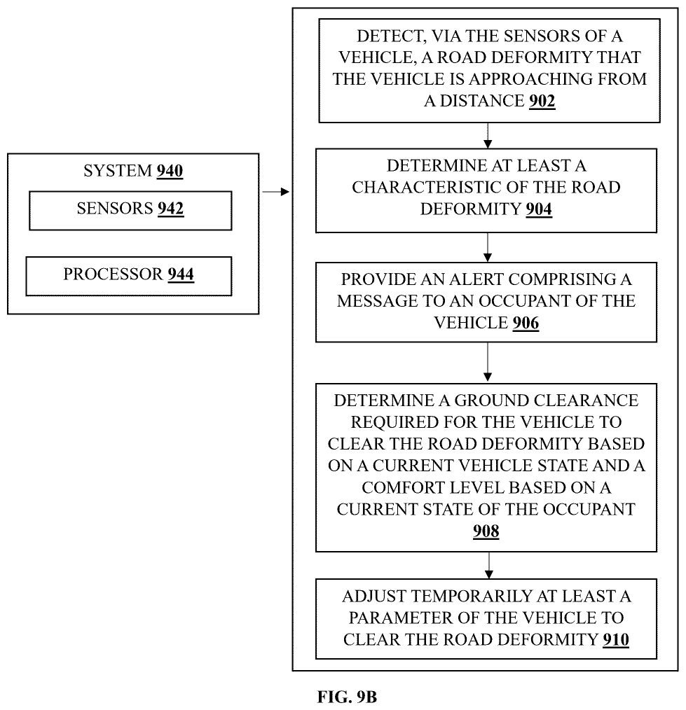

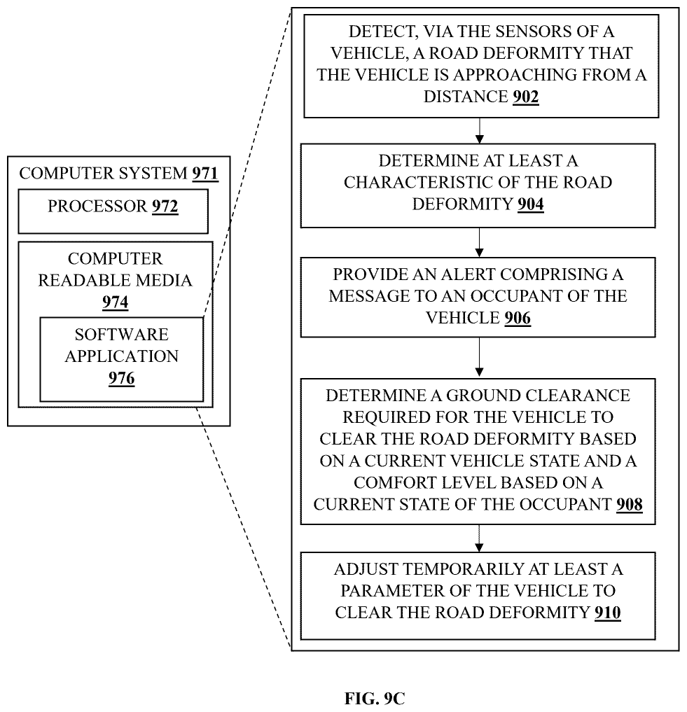

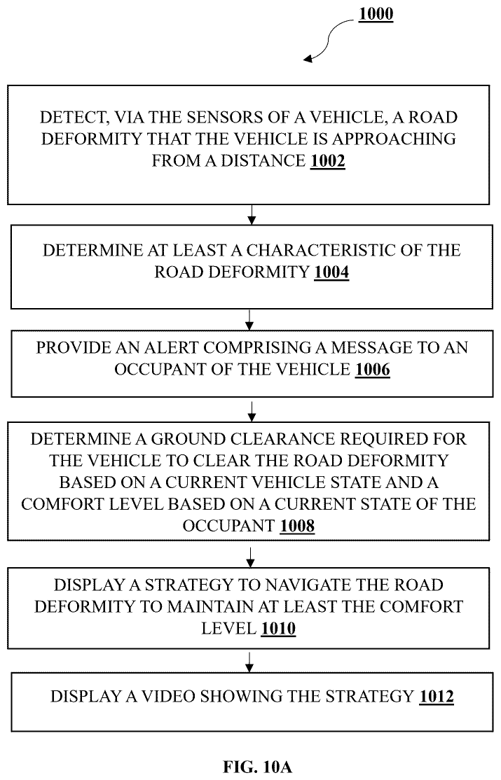

FIG. 9A shows a block diagram of a method executed by the vehicle to modify the functionality of the vehicle based on road deformity information according to an embodiment.

According to an embodiment, disclosed is a method 900 comprising detect, via one or more sensors of a vehicle, a road deformity that the vehicle is approaching from a distance at step 902; determining at least a characteristic of the road deformity at step 904; providing an alert comprising a message to an occupant of the vehicle at step 906; determining a ground clearance required for the vehicle to clear the road deformity based on a current vehicle state and a comfort level based on a current state of the occupant at step 908; and adjusting temporarily at least a parameter of the vehicle to clear the road deformity at step 910.

FIG. 9B shows a block diagram of a system of a vehicle to modify the functionality of the vehicle based on a road deformity information according to an embodiment.

According to an embodiment, disclosed is a system comprising one or more sensors 942; and a processor 944 storing instructions in non-transitory memory that, when executed, cause the processor 944 to detect, via the sensors of a vehicle, a road deformity that the vehicle is approaching from a distance at step 902; determine at least a characteristic of the road deformity at step 904; provide an alert comprising a message to an occupant of the vehicle at step 906; determine a ground clearance required for the vehicle to clear the road deformity based on a current vehicle state and a comfort level based on a current state of the occupant at step 908; and adjust temporarily at least a parameter of the vehicle to clear the road deformity at step 910. In an embodiment, providing an alert message is optional.

FIG. 9C shows a block diagram of the method executed by the non-transitory computer-readable medium to modify the functionality of the vehicle based on a road deformity information according to an embodiment. According to an embodiment, disclosed is a non-transitory computer-readable medium 974 having stored thereon instructions executable by a computer system to perform operations comprising detecting, via one or more sensors of a vehicle, a road deformity that the vehicle is approaching from a distance at step 902; determining at least a characteristic of the road deformity at step 904; providing an alert comprising a message to an occupant of the vehicle at step 906; determining a ground clearance required for the vehicle to clear the road deformity based on a current vehicle state and a comfort level based on a current state of the occupant at step 908; and adjusting temporarily at least a parameter of the vehicle to clear the road deformity at step 910. A software application 976 may be stored on the computer-readable medium 974 and executed by a processor 972 of the computer system 971.

According to an embodiment of the non-transitory computer-readable medium, the ground clearance required is determined to pass the road deformity without scraping an underbody of the vehicle.

According to an embodiment of the non-transitory computer-readable medium, the parameter comprises one or more of a stiffness of a suspension system, a height of the suspension system, a mode of the vehicle, a speed of the vehicle.

According to an embodiment of the non-transitory computer-readable medium, the system further shares the road deformity and the characteristic of the road deformity to a cloud configurable to be used by one or more of an authority for maintenance, a map to depict the road deformity, and other vehicles.

According to an embodiment of the non-transitory computer-readable medium, the distance allows the vehicle to determine the alert and the parameters to adjust. According to an embodiment of the non-transitory computer-readable medium, the current vehicle state comprises a load in the vehicle or vehicle load.

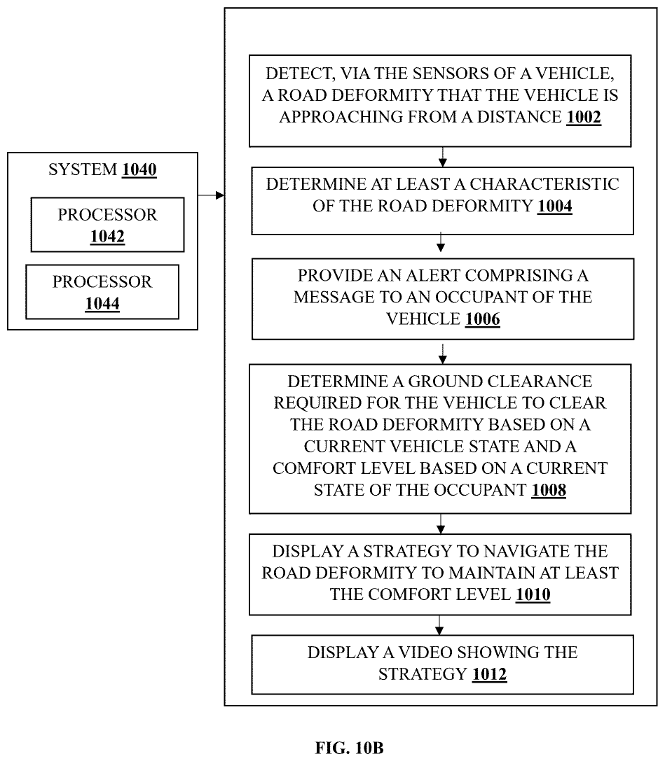

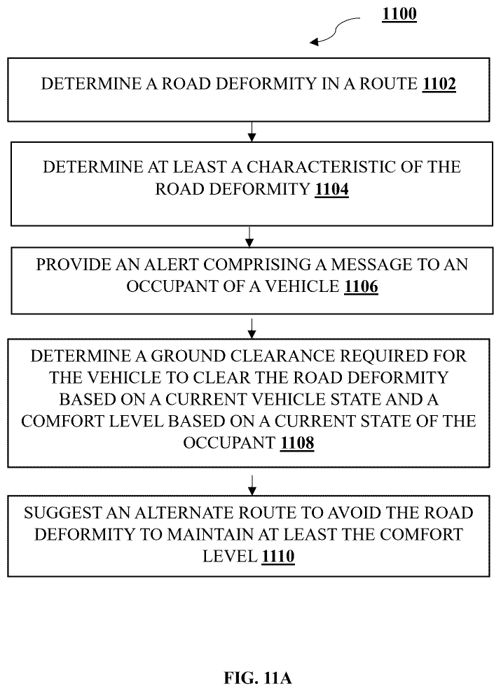

FIG. 10A shows a block diagram of a method executed by a vehicle to modify the functionality of the vehicle based on road deformity information according to an embodiment. According to an embodiment, disclosed is a method 1000 comprising detecting, via one or more sensors of a vehicle, a road deformity that the vehicle is approaching from a distance at step 1002; determining at least a characteristic of the road deformity at step 1004; providing an alert comprising a message to an occupant of the vehicle at step 1006; determining a ground clearance required for the vehicle to clear the road deformity based on a current vehicle state and a comfort level based on a current state of the occupant at step 1008; and displaying a strategy to navigate the road deformity to maintain at least the comfort level at step 1010; and displaying a video showing the strategy at step 1012. In an embodiment, providing an alert comprising a message to an occupant of the vehicle is optional.

FIG. 10B shows a block diagram of a system of a vehicle to modify the functionality of the vehicle based on road deformity information according to an embodiment. According to an embodiment, disclosed is a system 1040 comprising one or more sensors 1042; and a processor 1044 storing instructions in non-transitory memory that, when executed, cause the processor to detect, via the sensors of a vehicle, a road deformity that the vehicle is approaching from a distance at step 1002; determine at least a characteristic of the road deformity at step 1004; provide an alert comprising a message to an occupant of the vehicle at step 1006; determine a ground clearance required for the vehicle to clear the road deformity based on a current vehicle state and a comfort level based on a current state of the occupant at step 1008; and display a strategy to navigate the road deformity to maintain at least the comfort level at step 1010; and display a video showing the strategy at step 1012.

According to an embodiment of the system, the strategy comprises a steering wheel position to control a position and an orientation of a road wheel while crossing the road deformity. According to an embodiment of the system, the strategy further comprises a speed at which the vehicle crosses the road deformity. According to an embodiment of the system, the strategy further comprises adjusting one or more of stiffness of a suspension system, and a height of the suspension system.

According to an embodiment of the system, the current vehicle state comprises a load in the vehicle.

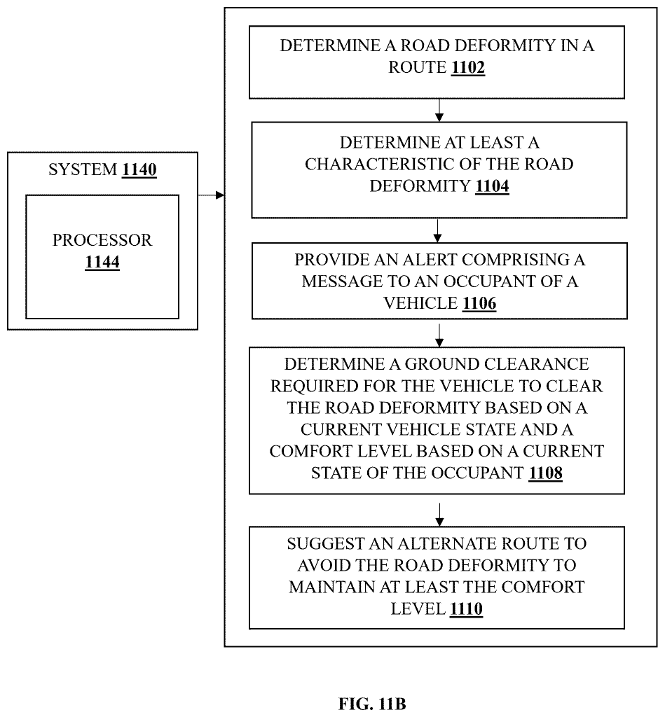

FIG. 11A shows a block diagram of a method executed by a vehicle to modify a route of the vehicle based on road deformity information according to an embodiment. According to an embodiment, disclosed is a method 1100 comprising determining, a road deformity in a route at step 1102; determining at least a characteristic of the road deformity at step 1104; providing an alert comprising a message to an occupant of a vehicle at step 1106; determining a ground clearance required for the vehicle to clear the road deformity based on a current vehicle state and a comfort level based on a current state of the occupant at step 1108; and suggesting an alternate route to avoid the road deformity to maintain at least the comfort level at step 1110. In an embodiment, determining at least a characteristic of the road deformity is optional.

FIG. 11B shows a block diagram of a system of a vehicle to modify a route of the vehicle based on road deformity information according to an embodiment. According to an embodiment, disclosed is a system 1140 comprising a processor 1144 storing instructions in non-transitory memory that, when executed, cause the processor to determine, a road deformity in a route at step 1102; determine at least a characteristic of the road deformity at step 1104; provide an alert comprising a message to an occupant of a vehicle at step 1106; determine a ground clearance required for the vehicle to clear the road deformity based on a current vehicle state and a comfort level based on a current state of the occupant at step 1108; and suggest an alternate route to avoid the road deformity to maintain at least the comfort level at step 1110. In an embodiment, providing an alert comprising a message to an occupant is an optional step. In an embodiment, determining a ground clearance required for the vehicle to clear the road deformity is based on a current vehicle state.

According to an embodiment of the system, the road deformity comprises a speed bump and wherein the characteristic comprises one or more of a height of the speed bump, a width of the speed bump, a spread of the speed bump. According to an embodiment of the system, the road deformity comprises a pothole and wherein the characteristic comprises one or more of a depth of the pothole, a width of the pothole.

According to an embodiment of the system, the system monitors a cabin of the vehicle to determine the current state of the occupant, using one or more machine learning algorithms. According to an embodiment of the system, the machine learning algorithms comprise Convolutional Neural Networks (CNNs).

According to an embodiment of the system, the system further considers historical data available on the route. According to an embodiment of the system, the system further considers data available on a database on a cloud about the route. According to an embodiment of the system, the current vehicle state comprises a load in the vehicle.

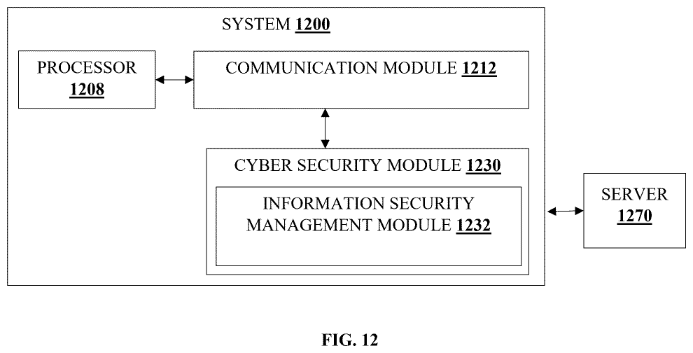

FIG. 12 shows the block diagram of the cyber security module 1230 in view of the system and server according to an embodiment. The communication of data between the processor 1208 of system 1200 and the server 1270 through the communication module 1212 is first verified by the information security management module 1232 before being transmitted from the system to the server or from the server to the system. Cyber security module 1230 comprises information security management module 1232. The information security management module is operable to analyze the data for potential cyber security threats, to encrypt the data when no cyber security threat is detected, and to transmit the data encrypted to the system or the server. In an embodiment, the cyber security module further comprises an information security management module providing isolation between the system and the server. In an embodiment, the system comprises methods for securing the data through the cyber security module. The information security management module is operable to receive data from the communication module, exchange a security key at the start of the communication between the communication module and the server, receive a security key from the server, authenticate an identity of the server by verifying the security key, analyze the security key for potential cyber security threats, negotiate an encryption key between the communication module and the server, receive the encrypted data, transmit the encrypted data to the server when no cyber security threat is detected. In an embodiment, the system comprises decryption of data by the cyber security module according to an embodiment. In an embodiment, the system comprises methods for securing the data through the cyber security module. The information security management module is operable to receive data from the communication module, exchange a security key at a start of the communication between the communication module and the server, receive a security key from the server, authenticate an identity of the server by verifying the security key, analyze the security key for potential cyber security threats, negotiate an encryption key between the communication module and the server, receive encrypted data, decrypt the encrypted data, and perform an integrity check of the decrypted data, transmit the decrypted data to the communication module when no cyber security threat is detected.

In an embodiment, the integrity check is a hash-signature verification using a Secure Hash Algorithm 256 (SHA256) or a similar method. In an embodiment, the information security management module is configured to perform asynchronous authentication and validation of the communication between the communication module and the server. In an embodiment, the information security management module is configured to raise an alarm if a cyber security threat is detected. In an embodiment, the information security management module is configured to discard the encrypted data received if the integrity check of the encrypted data fails. In an embodiment, the information security management module is configured to check the integrity of the decrypted data by checking accuracy, consistency, and any possible data loss during the communication through the communication module. In an embodiment, the server is physically isolated from the system through the information security management module. When the system communicates with the server as shown in FIG. 12, identity authentication is first carried out on the system and the server. The system is responsible for communicating/exchanging a public key of the system and a signature of the public key with the server. The public key of the system and the signature of the public key are sent to the information security management module. The information security management module decrypts the signature and verifies whether the decrypted public key is consistent with the received original public key or not. If the decrypted public key is verified, the identity authentication is passed. Similarly, the system and the server carry out identity authentication on the information security management module. After the identity authentication is passed on to the information security management module, the two communication parties, the system, and the server, negotiate an encryption key and an integrity check key for data communication of the two communication parties through the authenticated asymmetric key. A session ID number is transmitted in the identity authentication process, so that the key needs to be bound with the session ID number; when the system sends data to the outside, the information security gateway receives the data through the communication module, performs integrity authentication on the data, then encrypts the data through a negotiated secret key, and finally transmits the data to the server through the communication module. When the information security management module receives data through the communication module, the data is decrypted first, integrity verification is carried out on the data after decryption, and if verification is passed, the data is sent out through the communication module; otherwise, the data is discarded.

In an embodiment, the identity authentication is realized by adopting an asymmetric key with a signature. In an embodiment, the signature is realized by a pair of asymmetric keys which are trusted by the information security management module and the system, wherein the private key is used for signing the identities of the two communication parties, and the public key is used for verifying that the identities of the two communication parties are signed. Signing identity comprises a public and a private key pair. In other words, signing identity is referred to as the common name of the certificates which are installed in the user's machine. In an embodiment, both communication parties need to authenticate their own identities through a pair of asymmetric keys, and a task in charge of communication with the information security management module of the system is identified by a unique pair of asymmetric keys. In an embodiment, the dynamic negotiation key is encrypted by adopting an Rivest-Shamir-Adleman (RSA) encryption algorithm. RSA is a public-key cryptosystem that is widely used for secure data transmission. The negotiated keys include a data encryption key and a data integrity check key.

In an embodiment, the data encryption method is a Triple Data Encryption Algorithm (3DES) encryption algorithm. The integrity check algorithm is a Hash-based Message Authentication Code (HMAC-MD5-128) algorithm. When data is output, the integrity check calculation is carried out on the data, the calculated Message Authentication Code (MAC) value is added with the header of the value data message, then the data (including the MAC of the header) is encrypted by using a 3DES algorithm, the header information of a security layer is added after the data is encrypted, and then the data is sent to the next layer for processing. In an embodiment the next layer refers to a transport layer in the Transmission Control Protocol/Internet Protocol (TCP/IP) model. The information security management module ensures the safety, reliability, and confidentiality of the communication between the system and the server through the identity authentication when the communication between the two communication parties starts the data encryption and the data integrity authentication. The method is particularly suitable for an embedded platform which has less resources and is not connected with a Public Key Infrastructure (PKI) system and can ensure that the safety of the data on the server cannot be compromised by a hacker attack under the condition of the Internet by ensuring the safety and reliability of the communication between the system and the server.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

1-53. (canceled)

54. A system comprising:
one or more sensors; and
a processor storing instructions in non-transitory memory that, when executed, cause the processor to:
detect, via the sensors of a vehicle, a road deformity that the vehicle is approaching from a distance;
determine at least a characteristic of the road deformity;
provide an alert comprising a message to an occupant of the vehicle;
determine a ground clearance required for the vehicle to clear the road deformity based on a current vehicle state and a comfort level based a current state of the occupant; and
adjust temporarily at least a parameter of the vehicle to clear the road deformity.

55. The system of claim 54, wherein the sensors comprise one or more of camera-based sensors, a Radio Detection and Ranging, a Light Detection and Ranging, an ultrasonic sensor, a thermal imaging camera, and an infrared camera.

56. The system of claim 54, wherein the road deformity comprises a speed bump and wherein the characteristic comprises one or more of a height of the speed bump, a width of the speed bump, a spread of the speed bump.

57. The system of claim 54, wherein the road deformity comprises a pothole and wherein the characteristic comprises one or more of a depth of the pothole, a width of the pothole.

58. The system of claim 54, wherein the system further comprises determining the current state of the occupant using a camera-based sensor and one or more machine learning models by monitoring an interior of the vehicle; and wherein the current state of the occupant is one of sleeping, eating, driving, sitting, talking, reading, using mobile, and listening to a device.

59. The system of claim 54, wherein the system further considers information available on the road deformity from a cloud.

60. The system of claim 54, wherein the parameter is adjusted by sending a control signal by the vehicle to a subsystem of the vehicle.

61. The system of claim 54, wherein the parameter comprises one or more of a stiffness of a suspension system, a height of the suspension system, a mode of the vehicle, a speed of the vehicle.

62. The system of claim 61, wherein the height of the suspension system is adjusted via one of electronically adjustable height suspension springs, adjusting air pressure in air suspension system, adjusting fluid pressure in hydraulic suspension, controlling magnetic field of magnetic shock absorbers.

63. The system of claim 61, wherein the stiffness of the suspension system is adjusted via one of active dampers, adjusting coil overs, adjusting air pressure in air suspension system, and adjusting fluid pressure in hydraulic suspension.

64. The system of claim 61, wherein the mode of the vehicle comprises one of a sports mode, an eco-mode, off-road mode, a comfort mode.

65. The system of claim 54, wherein the system is further configured to display a video showing a strategy to navigate the road deformity.

66. The system of claim 54, wherein the message comprises one or more of information on the road deformity, the characteristic of the road deformity, and information on the parameter of the vehicle that is adjusted.

67. The system of claim 54, wherein the system further determines a route on which the vehicle is traveling and determines the road deformity that is present on the route via a cloud.

68. The system of claim 54, wherein the current vehicle state comprises a load in the vehicle.

69. A method comprising:
detecting, detect, via one or more sensors of a vehicle, a road deformity that the vehicle is approaching from a distance;
determining at least a characteristic of the road deformity;
providing an alert comprising a message to an occupant of the vehicle;
determining a ground clearance required for the vehicle to clear the road deformity based on a current vehicle state and a comfort level based a current state of the occupant; and
adjusting temporarily at least a parameter of the vehicle to clear the road deformity.

70. The method of claim 69, wherein the parameter comprises one or more of a stiffness of a suspension system, a height of the suspension system, a mode of the vehicle, a speed of the vehicle.

71. A non-transitory computer-readable medium having stored thereon instructions executable by a computer system to perform operations comprising:
detecting, detect, via one or more sensors of a vehicle, a road deformity that the vehicle is approaching from a distance;
determining at least a characteristic of the road deformity;
providing an alert comprising a message to an occupant of the vehicle;
determining a ground clearance required for the vehicle to clear the road deformity based on a current vehicle state and a comfort level based a current state of the occupant; and
adjusting temporarily at least a parameter of the vehicle to clear the road deformity.

72. The non-transitory computer-readable medium of claim 71, wherein the computer system further shares the road deformity and the characteristic of the road deformity to a cloud configurable to be used by one or more of an authority for maintenance, a map to depict the road deformity, and other vehicles.

73. The non-transitory computer-readable medium of claim 71, wherein the distance allows the vehicle to determine the parameter to adjust and the alert.
